(19) United States
(12) Patent Application Publication
(10) Pub. No.: US 2022/0374841 A1
(43) Pub. Date: Nov. 24, 2022

(54) LOCATION-BASED SERVICES MANAGER WITH BIOMETRIC RESOURCE VALIDATION

(71) Applicant: Fuzul Inc., Irvine, CA (US)

(72) Inventor: Manuchehr Khoshbin, Irvine, CA (US)

(73) Assignee: Fuzul Inc., Irvine, CA (US)

(21) Appl. No.: 17/881,344

(22) Filed: Aug. 4, 2022

Related U.S. Application Data
(63) Continuation-in-part of application No. 15/745,711, filed on Jan. 17, 2018, now abandoned.
(60) Provisional application No. 62/199,815, filed on Jul. 31, 2015.

(51) Int. Cl. G06Q 10/10; H04L 67/52

(52) U.S. Cl. CPC G06Q 10/1053; H04L 67/52

(57) ABSTRACT

A location-based services manager provides a forum for users to post jobs to appropriate resources. Such jobs may be associated with type information, scheduling information, location information, pay rate information, and/or other appropriate information. Resources may be able review job postings and respond as appropriate. The location-based services manager may identify relevant resources based on criteria such as availability, qualifications, location, etc. The job poster may review the responses and select one or more resources to perform the job. The location-based services manager may be used by the parties to monitor job performance, indicate completion, review performance, and facilitate payment.

### CROSS-REFERENCE TO RELATED APPLICATIONS

This application is a continuation-in-part of U.S. patent application Ser. No. 15/745,711, filed on Jan. 17, 2018. U.S. patent application Ser. No. 15/745,711 claims priority to PCT application PCT/US2016/044050, filed on Jul. 26, 2016. PCT application PCT/US2016/044050 claims priority to U.S. Provisional Patent Application Ser. No. 62/199,815, filed on Jul. 31, 2015. U.S. Patent Publication US 2018/0213267 A1, published on Jul. 26, 2018, is incorporated by reference herein.

### BACKGROUND

Many users may wish to receive information related to objects, people, etc. that the users are not able to observe in person.

Smartphones and tablets are ubiquitous in society. Such devices typically include media display and playback features (e.g., a touchscreen, speakers, etc.). In addition, such devices typically include media capture features (e.g., cameras, microphones, etc.). The devices are further able to communicate across one or more networks and provide location information (e.g., Global Positioning System (GPS) coordinates).

Therefore, there exists a need for a solution that allows users to request, from another user, location-based service including media information related to subject matter that is not able to be accessed or otherwise performed by the requester user.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates an example overview of one or more embodiments described herein, in which a job is posted and distributed to appropriate resources;

FIG. 2 illustrates an example overview of one or more embodiments described herein, in which resources are selected to perform a job;

FIG. 3 illustrates an example overview of one or more embodiments described herein, in which job completion is confirmed and payment is processed;

FIG. 4 illustrates a schematic block diagram of a distributed surveillance system according to an exemplary embodiment;

FIG. 5 illustrates a schematic block diagram of an exemplary user device of the system FIG. 4;

FIG. 6 illustrates a flow chart of an exemplary process that generates a user profile and account;

FIG. 7 illustrates a flow chart of an exemplary process that receives job postings and identifies matching resources;

FIG. 8 illustrates a flow chart of an exemplary process that selects resources to perform a job;

FIG. 9 illustrates a flow chart of an exemplary process that confirms job performance;

FIG. 10 illustrates a flow chart of an exemplary process that provides distributed surveillance;

FIG. 11 illustrates a flow chart of an exemplary client-side process that receives surveillance requests;

FIG. 12 illustrates a flow chart of an exemplary server-side process that receives surveillance requests;

FIG. 13 illustrates a flow chart of an exemplary client-side process that presents surveillance requests to potential responders;

FIG. 14 illustrates a flow chart of an exemplary server-side process that receives responses to surveillance requests from;

FIG. 15 illustrates a flow chart of an exemplary client-side process that receives response selections from requesters;

FIG. 16 illustrates a flow chart of an exemplary client-side process that presents assignments to responders;

FIG. 17 illustrates a flow chart of an exemplary server-side process that receives response selections from requesters and sends assignments to selected responders;

FIG. 18 illustrates a flow chart of an exemplary client-side process that captures and processes media for a responder;

FIG. 19 illustrates a flow chart of an exemplary server-side process that captures and processes media from a responder;

FIG. 20 illustrates a flow chart of an exemplary client-side process that retrieves and presents media to a requester;

FIG. 21 illustrates a flow chart of an exemplary server-side process that retrieves and provides media to a requester;

FIG. 22 illustrates a flow chart of an exemplary process that implements machine learning;

FIG. 23 illustrates a message flow diagram of an exemplary communication algorithm;

FIG. 24 illustrates an exemplary graphical user interface (GUI) that presents surveillance options to users;

FIG. 25 illustrates an exemplary GUI that presents requests to potential responders using a map-based view;

FIG. 26 illustrates an exemplary GUI that allows responders to search for available requests;

FIG. 27 illustrates an exemplary GUI that presents requests to potential responders using a list-based view;

FIG. 28 illustrates an exemplary GUI that presents a request to a potential responder;

FIG. 29 illustrates an exemplary GUI that generates a request;

FIG. 30 illustrates an exemplary GUI that presents a queue to a requester;

FIG. 31 illustrates an exemplary GUI that provides a list of responders to a requester;

FIG. 32 illustrates an exemplary GUI that provides information regarding a particular responder;

FIG. 33 illustrates an exemplary GUI that provides information regarding a request after a responder has been selected;

FIG. 34 illustrates an exemplary GUI that provides streaming surveillance between a responder and a requester;

FIG. 35 illustrates an exemplary GUI that receives job posting information;

FIG. 36 illustrates an exemplary GUI that receives job scheduling information;

FIG. 37 illustrates an exemplary GUI that receives job requirement information;

FIG. 38 illustrates an exemplary GUI that receives job detail information;

FIG. 39 illustrates an exemplary GUI that provides job postings;

FIG. 40 illustrates an exemplary GUI that provides communication between parties;

FIG. 41 illustrates an exemplary GUIs that provide dispute resolution;

FIG. 42 illustrates an exemplary GUI that receives scheduling information; and

FIG. 43 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments provide a location-based services manager. Such a services manager may allow parties to post location-specific job requests, evaluate responses, select a resource to perform the job, monitor and review performance, and process billing and payment.

The location-based services manager may validate user credentials (e.g., payment information, licensing or certificates, identity, etc.) and provide a secure environment through which to procure and manage location-based services. The location-based services manager may provide various categories and sub-categories of services that may define various specific job types. A job poster may select a job type and post a job offer including information such as job type, job location, deadline and/or scheduling requirements, proposed fee, etc.

Relevant and appropriate resources may be identified by the location-based services manager based on various appropriate criteria (e.g., location, qualifications, availability, etc.). Resources may be identified based on various matching rules or models. The job posting may be provided to the matching resources, who may respond to the job posting and/or communicate with the job poster via the location-based services manager of some embodiments.

The job poster may select one or more responders to perform the job via the location-based services manager. Job performance may be monitored and confirmed by each party. Any disputes that arise may be resolved via the location-based services manager. Upon completion, billing and payment may be processed via the location-based services manager.

Some embodiments provide a distributed surveillance network. A requester may be able to generate an assignment or task, including a specified rate, a location, and/or other relevant information. The assignment may then be presented to various potential responders. One or more of the potential responders may indicate a desire to accept the assignment. The requester may be able to select from among the actual responders and the task may be assigned to the selected responder. The responder may proceed to fulfill the task request by collecting media (e.g., pictures, video, etc.). The media may then be provided to the requester. Some embodiments may allow real-time streaming of media and two-way communication that allows the requester and responder to interact during capture/streaming of the media content.

Some embodiments provide ways to request surveillance of various locations, objects, and/or people. A requester may generate a request including a location, type, payment rate, and/or other appropriate parameters.

The request may be analyzed at a server and distributed to a set of potential responders. The set of potential responders may be identified based on various attributes of the responders (e.g., location, type, rating, etc.).

Each potential responder may have an opportunity to apply for the request. The server may generate a list of potential responders based on received applications. The list may be sent to the requester for selection of a particular responder.

The requester may select the particular responder and the particular responder may be notified of the assignment.

The responder may indicate when the responder is available to fulfill the request by capturing media at the specified location. Depending on the availability of the responder and requester, the surveillance may be performed as a real time streaming event. Alternatively, the responder may complete the request and the captured media may be stored and made available to the requester.

The requester may receive the captured media in real time or at a later time depending on the type of request. During a streaming event, the requester and responder may be able to communicate.

In one aspect, a machine implemented method of requesting multimedia is disclosed wherein the method includes transmitting a request for multimedia, via a requester device, said request comprising a description and location, receiving the request, via a server, transmitting one or more responder notices to one or more responders within a predetermined area of the location, via the server, receiving the one or more responder notices, via one or more responder devices, transmitting one or more responses from the one or more responders, via the one or more responder devices, receiving the one or more responses, via the server, selecting a respondent from the one or more responders, via the server, transmitting the request to the respondent, via the server, receiving the request, via one of the one or more responder devices, and at least one of recording and streaming the multimedia, via the one of the one or more responder devices.

Preferably, the method further includes receiving the multimedia, via the server, recording the multimedia, via the server, transmitting a requester notice, via the server, and receiving the multimedia, via the requester device.

In another aspect, a machine implemented method of obtaining multimedia is disclosed wherein the method includes transmitting a request for multimedia, via a requester device, said request comprising a description and location, and receiving the multimedia, via the requester device, wherein the multimedia is captured by a respondent, via a responder device, said respondent is selected from one or more responders within a predetermined area of the location. Preferably, a non-transitory machine-readable storage medium, which provides instructions that, when executed by a processing system, causes the processing system to perform operations according to a method as in this method. Preferably, a method of providing a user interface for obtaining multimedia, the user interface being accessible via the requester device, said method comprising a method as in this method. Preferably, a non-transitory machine-readable storage medium, which provides instructions that, when executed by a processing system, causes the processing system to perform operations according to a method as in this method.

In another aspect, a machine implemented method of requesting multimedia is disclosed wherein the method includes receiving a request for multimedia, via a server, said request comprising a description and location, transmitting one or more responder notices to one or more responders within a predetermined area of the location, via the server, receiving one or more responses from the one or more responders, via the server, selecting a respondent from the one or more responders, via the server, transmitting the request to the respondent; via the server, receiving the multimedia, via the server, recording the multimedia, via the server, and transmitting a requester notice, via the server. Preferably, a non-transitory machine-readable storage medium, which provides instructions that, when executed by a processing system, causes the processing system to perform operations according to a method as in this method. Preferably, a method of providing a user interface for requesting multimedia, the user interface being accessible via the server, said method comprising a method as in this method. Preferably, a non-transitory machine-readable storage medium, which provides instructions that, when executed by a processing system, causes the processing system to perform operations according to a method as in this method.

In another aspect, a machine implemented method of capturing multimedia is disclosed wherein the method includes receiving a responder notice, via a device, transmitting a response, via the device, receiving a request for multimedia, via the device, said request comprising a description and location, and at least one of recording and streaming the multimedia, via the device. Preferably, a non-transitory machine-readable storage medium, which provides instructions that, when executed by a processing system, causes the processing system to perform operations according to a method as in this claim. Preferably, a method of providing a user interface for capturing multimedia, the user interface being accessible via the device, said method comprising a method as in this method. Preferably, a non-transitory machine-readable storage medium, which provides instructions that, when executed by a processing system, causes the processing system to perform operations according to a method as in this method.

In another aspect, a computer network system for requesting multimedia is disclosed wherein the system includes a requester device having a processing unit and program code stored on a storage device of said requester device, said program code to perform a requester method when executed by said processing unit, a server having a processing unit and program code stored on a storage device of said server, said program code to perform a server method when executed by said processing unit, one or more responder devices, each responder device having a processing unit and program code stored on a storage device of said responder device, said program code to perform a responder method when executed by said processing unit, said requester method, comprising transmitting a request for multimedia, said request comprising a description and location, said server method, comprising receiving the request, transmitting one or more responder notices to one or more responders within a predetermined area of the location, receiving one or more responses from the one or more responders, selecting a respondent from the one or more responders, and transmitting the request to the respondent, said responder method, comprising receiving the one or more responder notices, transmitting the one or more responses from the one or more responders, receiving the request, via one of the one or more responder devices, and at least one of recording and streaming the multimedia, via the one of the one or more responder devices.

Preferably, the program code of the server when executed by said processing unit of the server further performs steps of receiving the multimedia, recording the multimedia, and transmitting a requester notice, and wherein the program code of the requester device when executed by said processing unit of the requester device further performs a step of receiving the multimedia. Preferably, the multimedia includes at least one of text, audio, still images, animation, and video. Preferably, the location includes a street address, name of city, name of state, and name of country. Preferably, the description is one of a building-description and a person description. Preferably, at least one of the requester devices and the one or more responder devices is a smartphone.

Several more detailed embodiments are described in the sections below. Section I provides an overview of some embodiments. Section II then describes a hardware architecture of some embodiments. Next, Section III describes various methods of operation used by some embodiments. Section IV then describes various GUIs provided by some embodiments. Lastly, Section V describes a computer system which implements some of the embodiments.

### I. Overview and Examples

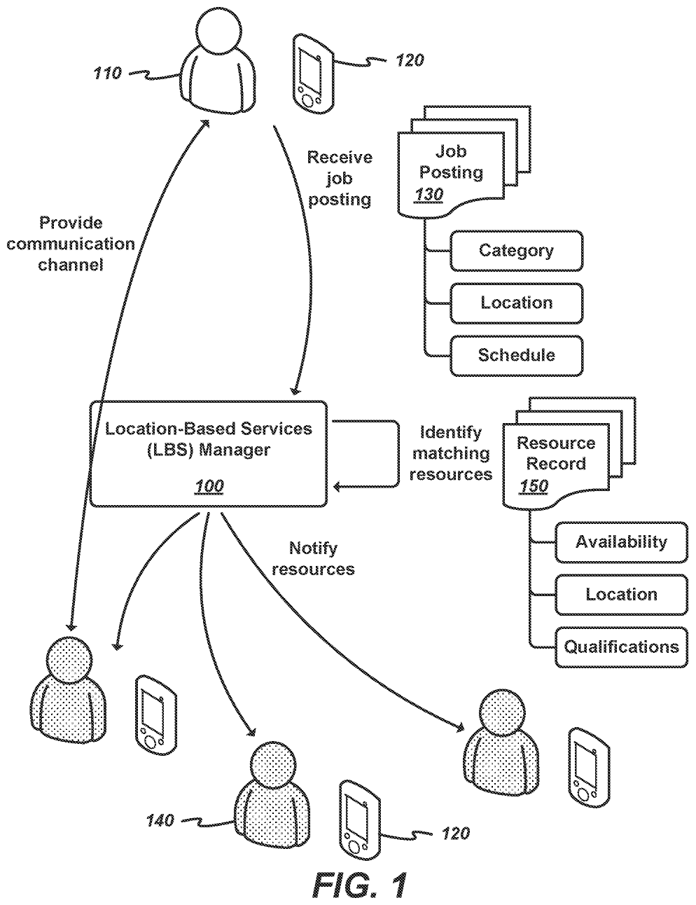

FIG. 1 illustrates an example overview of one or more embodiments described herein, in which a job is posted and distributed to appropriate resources. Jobs may typically be associated with services that are performed at a physical location, but may be associated with any services for hire.

As shown, a location-based services (LB S) manager 100 may receive a job posting from an entity such as a job poster or “poster-user” 110 via a user device 120 such as a smartphone. In some embodiments, LBS manager 100 may be at least partially implemented by, or via, the user device 120 (e.g., via a dedicated application of some embodiments, via a web browser, etc.). As described below, LBS manager 100 may include, communicate with, and/or otherwise utilize resources such as a server, storage, API, etc.

Each poster-user 110 may be associated with a user record or account profile. In this example, a job posting element 130 may include attributes or parameters such as a category, location, schedule, budget, type, and/or other relevant information. The job posting 130 may be received via a resource such as a graphical user interface (GUI) of some embodiments.

For instance, LBS Manager 100 may provide listings of options for selection by user 110. As an example, the category attribute may include discrete elements such as “cleaning”, “creative”, “handyman”, “events”, “inspection”, “general labor”, “livestream”, “media capture”, “photography”, “organization”, “pet care”, “talent”, “secret shopper”, etc. Categories and sub-categories may be associated and/or nested in various appropriate ways. Continuing this example, each category may be associated with a set of sub-categories. For instance, “cleaning” may be associated with sub-categories such as “home”, “office”, “car”, “window”, “pool”, etc. As another example, “creative” may be associated with sub-categories such as “decorating”, “design”, “arts and crafts”, etc. Likewise, other categories may include various associated sub-categories, such as handyman sub-categories (e.g., “home improvement”, “furniture assembly”, “appliance repair”, etc.), events sub-categories (e.g., “photography”, “chef services”, “bartending”, etc.), inspection sub-categories (e.g., “car”, “home”, “office”, “construction”, etc.), general labor sub-categories (e.g., “moving”, “hauling”, etc.), livestream sub-categories (e.g., “drone”, “open house”, “window”, “home”, “business”, “monitor workers”, etc.), photography sub-categories (e.g., “item”, “drone”, “real estate”, “automotive”, etc.), organization sub-categories (e.g., “packing”, “arranging”, “closet”, “garage”, etc.), pet care sub-categories (e.g., “walk”, “groom”, “sitting”, etc.), talent sub-categories (e.g., “actor”, “model”, “DJ”, etc.), and/or other relevant categories and/or sub-categories.

A location attribute may allow users to select from various options that may define a physical location for services to be performed. Example locations may include a street address, suite or apartment number, etc. In some cases, locations may be specified using a coordinate reference (e.g., GPS coordinates). In some cases, location may be specified based on an object or vehicle position or path. For instance, a user may request drone footage of a small aircraft during flight, performance along a bicycling course, waterskiing on a lake or bay, etc. In each case, a region or expected path may be provided.

The schedule attribute may allow the job poster 110 to provide requested scheduling information such as date, time, etc. In some cases, the schedule may be provided specifically, or with a deadline (e.g., “to be completed by 3 pm on July 1”). In some cases, a period of performance may be indicated (e.g., “construction to be performed between July 1 and July 15”) and/or acceptable work time (e.g., “work to be performed between 9 am and 4 pm on weekdays”). The schedule attribute may be used to define repeating services (e.g., “mow lawn every two weeks during summer and every four weeks during winter”).

A budget attribute may include or indicate various limits, guidelines, or fixed fee offers (e.g., “$300 paid upon completion”, “$50/hour”, “cost of labor and materials not to exceed $500”, etc.). In some cases, an open bid may be requested without any specified budget limits. In some embodiments, LBS manager 100 may provide suggested or nominal rates for various job types. Such rates may be based on information such as rates for similar jobs (e.g., similar or same type, similar location, etc.), machine learning models, and/or other relevant information, attributes, and/or algorithms. In addition, some job types may be associated with fixed rates and a list of providers that accept the fixed rate.

A type or “job type” attribute may include various specific jobs that may be commonly requested. Such job types may be associated with scheduling information (e.g., expected time to complete, typical delay before start, etc.), budget information (e.g., fixed price, local rate, etc.), and/or other appropriate associations. For example, under a category “landscaping”, a sub-category of “gardening” may include a listing of standard job types, such as “lawn mowing”, “tree trimming”, etc. As one example, lawn mowing may indicate scheduling information (e.g., “one hour per quarter acre”) and/or budget information (e.g., “$100 per quarter acre”).

Each job top may be associated with a set of required qualifications. For instance, a plumbing job may require an active local license or certificate. Similarly, an electrical job may require an active local license or certificate. A job poster may be able to specify other qualifications or attributes that may be required of a resource. For example, a job poster may require a minimum of five years of experience in the field. As another example, a job poster may require that resources have completed at least ten jobs via the LBS manager 100.

LBS manager 100 may receive the job posting and identify matching resources 140. Each resource 140 may be associated with a resource record 150 and/or other appropriate element that may define the services offered, pricing, availability, location, qualifications, and/or other appropriate attributes for a resource 140. Each resource 140 may be associated with a user device 120 that may be able to interact with LBS manager 100 (e.g., across one or more networks).

Matching resources 140 may be identified or filtered based on various relevant criteria, models, and/or rules. For instance, each resource record 150 may indicate one or more job categories that the resource 140 is available to perform (e.g., “cleaning”, “creative”, etc.). In some cases, the job categories may be limited or further specified (e.g., “cleaning/house cleaning”, “videographer/drone”, etc.). Thus, resources 140 that match a category specified in the job posting 130 may be included in a set of matching resources, while those that don't match the specified category may be excluded.

Matching resources 140 may be identified or filtered based on location in relation to the job posting 130. For example, all resources 140 within a ten-mile radius of the location specified in the job posting 130 may be identified or included in the set of matching resources 140. Resources 140 may be associated with various regions or locations. For instance, a resource 140 may be associated with a base location (e.g., an office or other business location) and may serve a radius around that location (e.g., a ten-mile radius). As another example, the current location of each resource 140 may be determined at regular intervals, or as new job postings 130 are generated. For instance, GPS coordinates may be received from a user device 120, indicating a current position of the resource-user 140. As another example, a resource 140 may indicate cities or regions within which the resource 140 may offer services. Some embodiments may utilize a “smart” radius, where the region or location associated with the resource may have a specific shape, a variable range depending on direction, etc.

Matching resources 140 may be identified or filtered based on availability or schedule. For instance, a resource record 150 may indicate days or times that the resource 140 has previously committed to perform services or is otherwise unavailable. The schedule specified by the job posting 130 may be used to identify resources 140 that are available to perform services at a specified time or may be able to complete services by a specified deadline.

Other examples of resource matching may include filtering based on required or specified qualifications (e.g., licensed plumber or electrician, insurance certification, professional engineer, membership in a trade group or society, etc.). As another example of resource matching, resources 140 that have previously received a low rating from poster-user 110 may be excluded. Matching resources 140 may be identified using various algorithms including those implemented using various machine learning models or other artificial intelligence (AI) features.

LBS manager 100 may notify the various matching resources 140 of the job posting 130 via a resource such as a push message, notification via a dedicated application of some embodiments, via email, and/or other appropriate ways. In some cases, resources 140 may search or otherwise access the LBS manager 100 (e.g., via a web browser or dedicated application of some embodiments) and retrieve appropriate jobs. In such cases, resources 140 may be able to browse or filter using attributes such as schedule, location, price, etc. Access to job postings 130 may be limited to qualified or otherwise matching resources. For example, a resource 140 may be associated with a particular location that is not a match to a job posting 130. However, the resource 140 may be planning to travel to a different area and may review job postings 130 associated with that area if the resource 140 is otherwise qualified (e.g., based on availability, certifications, etc.).

LBS manager 100 may provide a two-way communication channel between the poster-user 110 and the matching resources 140. Such a communication channel may allow the parties to pose or answer questions, negotiate pricing, modify a deadline or other performance attributes, etc. Such a communication channel may include text, video, audio, and/or other multimedia and may be implemented via various appropriate channels (e.g., text services, email, etc.).

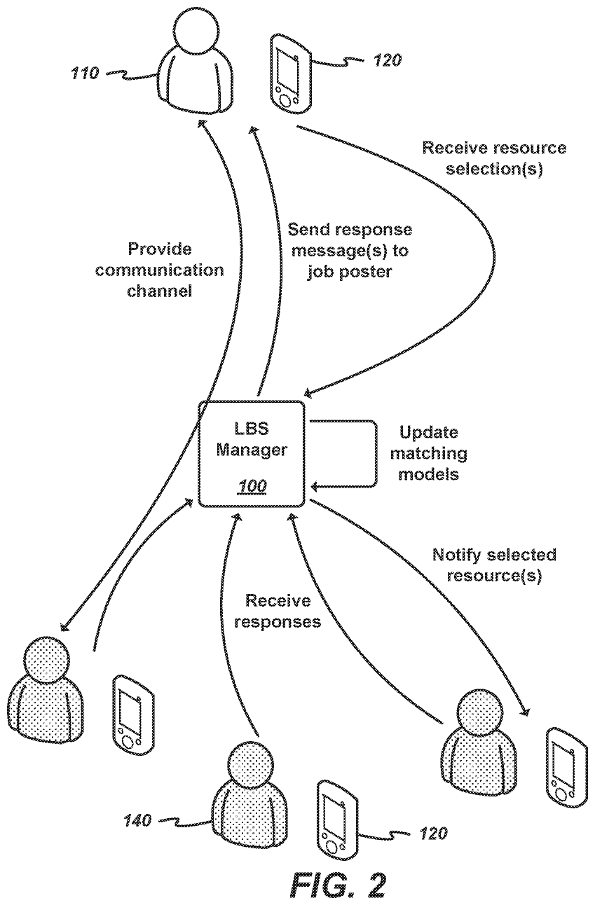

FIG. 2 illustrates an example overview of one or more embodiments described herein, in which resources are selected to perform a job. In this example, resources 140 that received a notification regarding the job posting 130 and/or other qualified resources may be able to respond to the job posting, indicating their willingness to perform the job according to the posted terms (e.g., schedule, price, etc.) and/or providing requested information (e.g., price, total cost, project plan, etc.).

LBS manager 100 may receive response(s) from resource(s) 140 and may send the received response message(s) to the job poster 110 for review. Such responses may include various relevant data. For instance, a flat fee project with a required performance schedule may be associated with a simple response indicating willingness to perform the job based on the specified terms. As another example, the responses may include references, testimonials, or other indications of past performance (e.g., pictures of similar completed projects) relevant to the job posting 130. Responses may be sent to the job poster 110 via push notification, dedicated application, email, and/or other relevant channels (e.g., when a job poster 110 accesses a web-based utility of some embodiments). In some embodiments, responses may include proposed or modified scheduling, pay, or other attributes.

The job poster 110 may review the response messages, use the communication channel to ask questions or otherwise interact with the resources 140, and/or otherwise evaluate the received responses and/or associated resources 140. For example, the job poster 110 may be able to review a profile associated with each resource 140, where the profile may include, for example, a resource rating (e.g., a rating based on a five-star scale), reviews or testimonials regarding previous performance, examples of previous work (e.g., pictures of completed gardening jobs, sample video footage captured by drone, etc.).

LBS manager 100 may receive one or more resource selections from the job poster 110, allowing for “multi-hiring” as appropriate. Each resource selection may include a resource identifier (ID) and/or other relevant information (e.g., final agreed price, schedule, etc.). LBS manager 100 may notify the selected resources (e.g., via a push message or email), where the notification may include various details related to the job posting 130, such as scheduling information, detailed location information, other instructions, listings of other selected resources (if any), and/or other relevant information.

During job performance, the communication channel may be used to monitor progress, request information, update terms, and/or otherwise manage job performance. For example, a resource may start a job and realize that additional materials are needed or that conditions require additional work time. The job poster may agree with the updates and assent to a different schedule and/or pay rate.

Based on the selections (and/or other relevant information, such as responding resources 140 that were not selected), LBS manager 100 may update the matching models used to identify matching resources 140. For instance, models may be updated such that selected resources 140 are more likely to be identified as matching resources with respect to future job postings. Likewise, such models may be updated such that non-selected (and/or non-responding) resources 140 are less likely to be identified as matching resources with respect to future job postings.

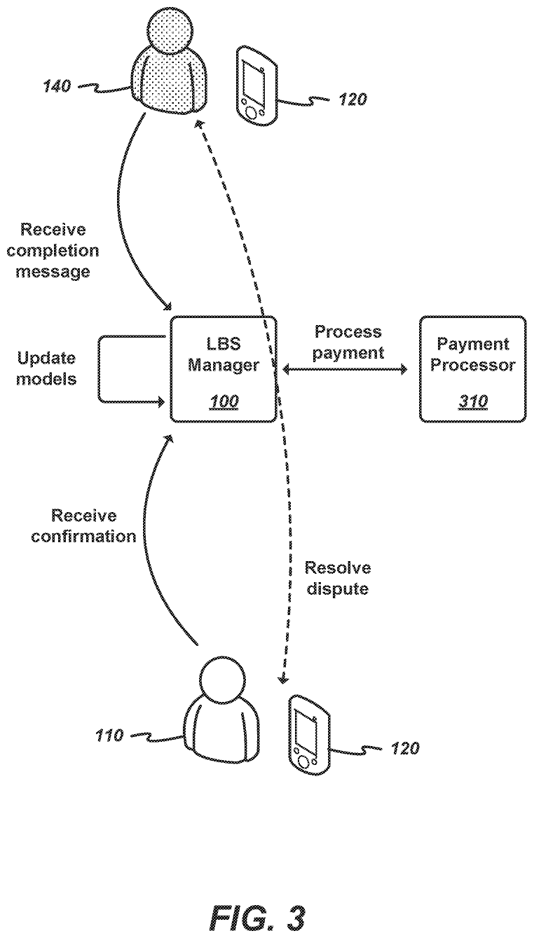

FIG. 3 illustrates an example overview of one or more embodiments described herein, in which job completion is confirmed and payment is processed. As shown, LBS manager 100 may receive a completion message from one or more resources 140 associated with a job. Such a completion message may be received via a dedicated application or web interface of some embodiments.

Similarly, the LBS manager 100 may receive confirmation from the job poster 110 that the job has been completed to the satisfaction of the job poster 110. Such confirmation may include review information (e.g., a star rating) and/or other appropriate feedback.

If the job poster 110 is not satisfied that the job has been completed properly and/or if the resource 140 is not satisfied with the terms of performance, dispute resolution may be facilitated via LBS manager 100. Such dispute resolution may include, for instance, communication between the parties, adjustment of the terms (e.g., extension of a deadline, reduction in price, etc.). In some cases, disputes may be resolved via external resources (e.g., a mediator or arbitrator).

If the job poster 110 is satisfied that the job has been properly completed, payment may be processed via LBS manager 100 and/or a payment processor 310 (e.g., a credit card processing resource, a digital wallet resource, etc.). For example, payment may be automatically received from a payment method associated with the job poster 110 (e.g., a credit card, a bank account, etc.) via an associated payment processor 310 (e.g., a credit card processing resource, a banking application programming interface (API), etc.) and funds may be distributed to the resource(s) 140 via an associated account or other receipt resource (e.g., a bank account, a digital wallet, etc.).

LBS manager 100 may update the various machine learning models and/or matching rules based on the project completion information (e.g., performance ratings, whether a dispute was raised, how any disputes were resolved, final payment amount, etc.).

In some cases, on-demand multimedia capture may be requested from individuals using the systems and methods described herein. A computer network system, which includes servers and smartphones communicating via the Internet and/or other networks using mobile applications (or “apps”), may be used by some embodiments. A requester may place a request for multimedia with the server which in turn selects a willing individual to capture the multimedia. The requester provides the location and description of the subject matter of the multimedia.

As one example, an individual residing in Irvine, Calif. may use a desktop computer to request someone near a particular building, for instance the John Hancock building in Chicago, Ill., to record a thirty second video of the front side of the building. The request (or “job” or “task”) may be sent to the server which may be in communication with individual responders who use mobile devices, such as smartphones. The server may send push notifications to responders who are within a predetermined area, for instance three miles of the building of such request.

Responders who are willing to perform the task may communicate their responses to the server which in turn may select one respondent (or “responder”) from the responders and provides the request to the respondent. The respondent may have the option of streaming the video to the server or recording it for uploading it to the server at a later time. The server may record the video and notify the requester of the availability of the video by sending a push notification to the requester. The requester then may download the video from the server to the desktop and play the video.

As another example, an individual residing in Tehran, Iran, may use a desktop computer to request someone near a particular place, for instance, Laguna Beach in Laguna Beach, Calif., to record a three-minute video of surf conditions at the beach. The request may be sent to the server and the server may send push notifications to responders who are within a predetermined area, for instance ten miles of the beach. Responders who are willing to perform the task may transmit their responses to the server and the server may select one respondent from the responders and provides the request to the respondent. As above, the respondent may have the option of streaming the video to the server or recording it on for future processing. Once the server receives the video, the server may notify the requester of the availability of the video and the requester may then download and view the video.

Some embodiments may allow the requester and the responders to communicate directly in a peer-to-peer (P2P) system without requiring a server. For instance, once the server has selected a respondent, the server may connect the requester to the respondent such that they can communicate directly.

Requests may not be limited to recording of video content. In certain settings, the request may involve recording of other multimedia. For instance, a request may ask for someone to enter a restaurant to observe an individual whose description is given in detail in the request. The respondent, who may not be able to capture video inside the restaurant, can observe the individual and enter text in his device describing what he is witnessing regarding the individual and also include photos of the individual in the restaurant.

There are over two billion people with smartphones in the world which all have cameras and recording capability. Some embodiments connect people who are in need of a way to witness a live event, person, object, etc. with users who would like to earn money by being the eyewitness for them using live streaming video.

Some embodiments use location services and global positioning satellite (GPS) technology to find users within the vicinity of a job location and send push notifications to such users about a task that has posted in their area.

Users may either post a task (“requesters”) or be the eye (“respondents” or “responders”) and earn money by accepting any of the posted tasks on the app.

For example, if a spouse states she is working late at the office and the other spouse has doubts, the other spouse may post a task asking for verification of whether a white minivan is seen at the parking lot of the work address of the spouse. The job may be posted and all users in that vicinity get a push notification.

Each potential responder may see how much is being offered and click an accept button if interested. Once accepted, the requester may view profiles of any responders and release the details of the job such that a responder may then confirm final acceptance and the job will stop accepting responses. For privacy reasons, on the map some embodiments may not disclose details on any spying related posts and may include only a spy icon and the rate offered.

Once the responder is on location, the requester may get push notification and may be able to open an app and watch the response live and communicate with the responder. If the requester is not available for live streaming, the finished clip may go into the inbox of the requester (and/or otherwise be stored or made available for the requester), the responder may get paid. The requester may be able to rate the responder after the assignment is complete.

As another example, a requester may receive a job offer in another state and need to find housing for relocation. The requester may identify three homes that fit the requirements of the requester, however the requester may not have time or resources to view the homes in person. The requester may hire an “eye” (or responder) to go out and live stream the properties and surrounding areas, thus avoiding paying for airline ticket, lodging, etc. and saving a lot of time.

Requesters may be required to pay the job cost upon creation of the job. For example, a requester may be willing to pay someone twenty dollars to inspect a car in another city. The requester may create an inspection task with the location of the car and pay the twenty dollars.

Next, the job may be made visible to other app users in the other city. The other users may apply to take the job.

The requester may then receive a notification when someone applies to take the job. The requester may review the profile and/or account information for the responder(s) prior to selecting or accepting a responder.

The selected responder may then perform the job and take a video of the car. The requester may watch the video live or via a recording.

The requester may then be able to accept the results or ask for additional media, communication, etc. from the responder.

Once the response is accepted, the responder may be paid the twenty dollars (or appropriate portion thereof).

### II. System Architecture

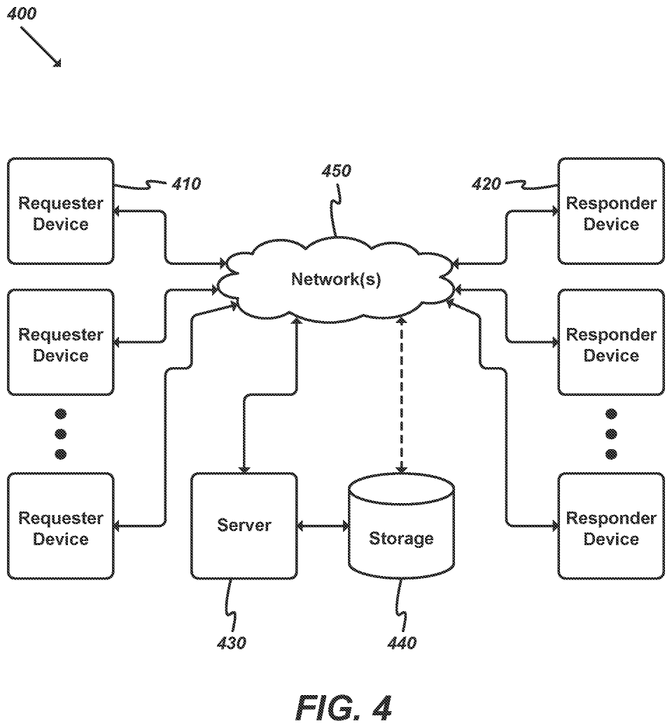

FIG. 4 illustrates a schematic block diagram of a distributed surveillance system 400 according to an exemplary embodiment. As shown, the system may include one or more requester devices 410, one or more responder devices 420, a server 430, a storage 440, and one or more networks 450. In some embodiments, functionality described with reference to the requester devices 410, responder devices 420, server 430, and/or storage 440 may be provided by, using, and/or via, the LBS manager 100 of some embodiments.

The requester device 410 may be a device capable of accessing the network 450. The requester device 410 may include other capabilities such as media playback, text or voice communication, etc. The requester device may be a device such as a smartphone, tablet, personal computer (PC), wearable device, etc. User device 120 is one example of such a requester device 410.

The responder device 420 may be a device capable of accessing the network 450. The responder device 420 may include other capabilities such a media capture, text or voice communication, etc. The responder device may be a device such as a smartphone, tablet, laptop, wearable device, etc. User device 120 is one example of such a responder device 420.

The server 430 may include one or more electronic devices able to process instructions, manipulate data, and communicate across one or more networks 450. The server 430 may include multiple physical devices distributed across multiple physical locations.

The storage 440 may be able to store data and/or instructions for use by other system components. The storage may be accessible via the server 430, via one or more APIs, and/or other appropriate ways.

The network 450 may include local area networks, cellular networks, distributed networks, the Internet, etc. Such networks may utilize various types of communication paths, interfaces, etc. The networks may allow the various other system components to communicate.

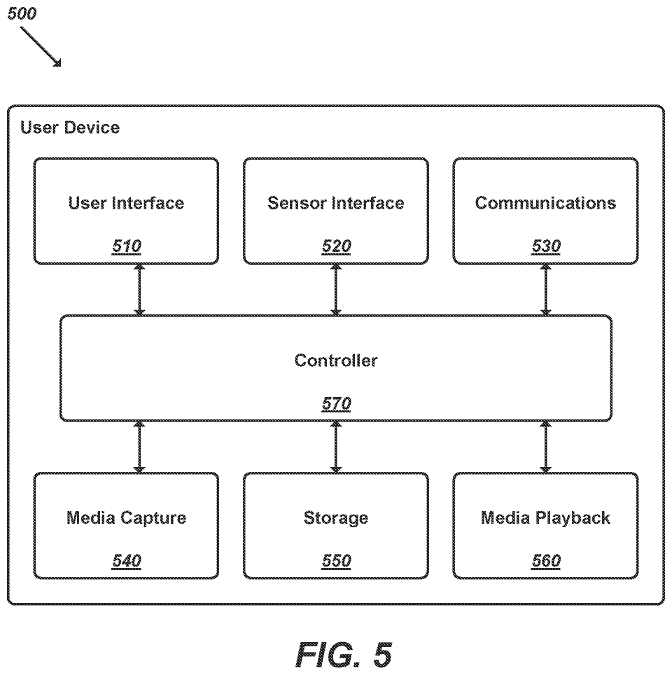

FIG. 5 illustrates a schematic block diagram of an exemplary user device 500 of the system 400. Such a user device 500 may serve as the requester device 410 and/or responder device 420. User device 120 is one example of a user device 500. As shown, the user device 500 may include a user interface module 510, a sensor interface module 520, a communications module 530, a media capture module 540, a storage 550, a media playback module 560, and a controller 570.

The user interface module 510 may be able to receive various user inputs (e.g., via a touchscreen, keypad, buttons, voice input, etc.) and/or provide various outputs to a user (e.g., via a video display screen, speakers, haptic feedback, etc.).

The sensor interface module 520 may be able to direct, receive data from, and/or otherwise interact with any sensors included in the user device 500. Such sensors may include, for instance, GPS modules, accelerometers, temperature sensors, etc.

The communications module 530 may be able to send and/or receive communications across various appropriate pathways. Such pathways may include networks 450, local connections (e.g., Bluetooth, USB, etc.), and/or other appropriate communication pathways or resources (e.g., messaging platforms, cellular communications, etc.).

The media capture module 540 may be able to interact with various device hardware elements to capture media. Such hardware elements may include, for instance, cameras, microphones, etc. The captured media may include picture or video content, audio content, etc. In addition, some embodiments may capture other information such as sensor outputs, user inputs, etc.

The storage 550 may be able to receive, store, and/or provide data and/or instructions from/to the other system components. Such a storage may be local to the user device 500 and/or may be accessible to the user device via one or more wired and/or wireless connections.

The media playback module 560 may be able to retrieve or receive media and provide the media to a user. Such a module may be able to interact with various appropriate hardware modules (e.g., a display screen, speakers or other audio output, etc.).

The controller 570 may allow communication among the other components. In addition, the controller may at least partly direct the operations of the other components.

One of ordinary skill in the art will recognize that the system 400 and/or device 500 described above may be implemented in various different ways without departing from the scope of the disclosure. For instance, the components may be arranged in various different ways. As another example, additional components may be included and/or listed components may be omitted. In addition, multiple components may be combined into a single component and/or a single component may be divided into multiple sub-components.

### III. Methods of Operation

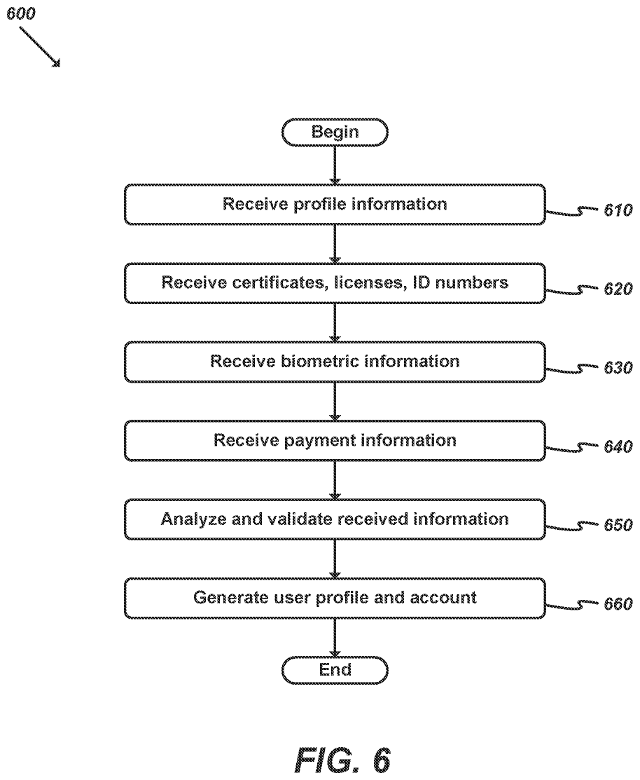

FIG. 6 illustrates an example process 600 for generating a user profile and account. Such a user profile and account may be generated for each poster-user 110 and each resource-user 140. The process may validate user identity, establish payment methods, apply profile information to a user account, and/or otherwise allow establishment of a user account. The process may be performed when a new user wishes to utilize the LBS manager 100. In some embodiments, process 600 may be performed by LBS manager 100.

As shown, process 600 may include receiving (at 610) profile information. Profile information may include, for a poster-user 100, information such as name, default location, type (e.g., individual, corporation, etc.), and/or other relevant profile information. For a resource-user 140 profile information may include, for example, name, primary location or business location, service region(s), default schedule information (e.g., typically works Monday-Friday from 10 am to 4 pm), and/or other relevant information. Service regions may be defined in various appropriate ways, such as using a primary location and radius about the primary location. As another example, a resource-user 140 may be able to move points on a map interface to define one or more polygonal service regions.

In some cases, resource-users 100 may select or indicate various services or jobs that the resource-user 110 is qualified for and available to perform. For instance, a resource-user 100 may indicate that the resource may be able to perform a variety of plumbing jobs. Such services and/or jobs may be selected from discrete listings (e.g., the categories and sub-categories described above, a listing of job types or specific jobs, etc.) and/or otherwise indicate (e.g., via text entry). As another example, resource-users 140 may be able to indicate skills or other relevant information.

Process 600 may include receiving (at 620) certificates, licenses, ID numbers, etc. For poster-users 110, such information may include, for example, building permit information, ownership information (e.g., a title or deed indicating that some property associated with a job is controlled by the poster-user 110), and/or other relevant information (e.g., tax ID numbers, corporation or other business entity registration number, etc.). For resource-users 140, such information may include, for instance, licenses or certificates associated with various types of services (e.g., a plumbing or electrical license number), tax ID number, business license number, etc.). Copies of certificates or other such documents may be uploaded to LBS manager 100 and/or may be retrieved by LBS manager 100 from various public directories or listings. Such certificates or licenses may be verified in various appropriate ways (e.g., by comparing to public records if available, using image recognition and verification models, etc.). Depending on the skills or capabilities indicated by a resource-user 140 profile, various certificate, license, and/or other information may be required to be submitted for verification. For instance, a resource 140 that indicates a capability to perform electrical services may have to provide a license number or certificate from a local authority.

The process may include receiving (at 630) biometric information. Biometric information may include, for example, a three-dimensional (3D) biometric selfie or other body scan, facial image, fingerprint information, DNA sample, and/or other relevant biometric sample that may be used to identify a person. In some embodiments, a 3D biometric selfie may be generated by a user via a smartphone or other appropriate device, where photos are taken at various angles to generate a 3D representation of the user.

As shown, process 600 may include receiving (at 640) payment information. For a poster-user 110, such information may include outgoing payment information such as bank account information, credit card information, digital wallet information, payment account information, etc. For a resource-user 140, such information may include incoming payment information such as bank account information, digital wallet information, online account information, etc.

Process 600 may include analyzing and validating (at 650) the received information. Analysis and validation may include various operations that may depend on the type(s) of information provided. For instance, third-party registration information (e.g., a license number) may be evaluated by retrieving information from a public database and comparing the information to that provided by the user. As another example, a small deposit or withdrawal may be applied to a bank account to verify user access to and/or ownership of the account. As still another example, a credit card or other payment account may be verified using a third-party credential (e.g., credit card information may be verified through one or more banking resources).

The process may include generating (at 660) a user profile and account. The user profile and account information may be stored to a file or record such as resource record 150. The user profile and account may be associated with identification and validation information (e.g., a username and password). A unique ID or serial number may be generated by the LBS manager 100 and assigned to, or otherwise be associated with, each poster-user 110, each resource 140 and/or resource record 150, each job posting 130, and/or other appropriate records associated with the LBS manager 100.

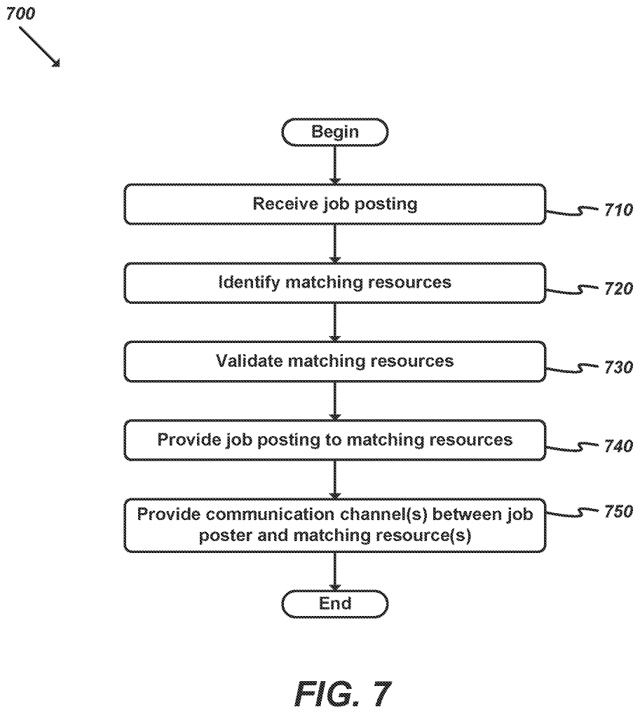

FIG. 7 illustrates an example process 700 for receiving job postings and identifying matching resources. Process 700 may be similar to the overview of FIG. 1 above. Process 700 may be performed when a job posting is initiated by a poster-user 110, such as by accessing a web resource or dedicated application of some embodiments. In some embodiments, process 700 may be performed by LBS manager 100.

As shown, process 700 may include receiving (at 710) a job posting, such as job posting 130. Such a job posting may be received via a resource such as a web-based interface or dedicated application. Various examples of GUIs used by some embodiments to receive such job postings are described below. The job posting may generally indicate terms of the job, such as type, schedule, price offered, etc.

Process 700 may include identifying (at 720) matching resources, such as resources 140. Matching resources may be identified based on various relevant criteria and/or evaluation of resource records 150. For instance, in some embodiments, matching resources must be physically located within ten miles of a specified job location. As another example, matching resources may be identified based on scheduling requirements of the job and availability of the resource. Matching resources may be filtered based on required skills, licenses, and/or other credentials associated with the resources. Matching resources may be filtered based on evaluation metrics or other criteria (e.g., a job poster may indicate that only resources with a rating of four or five stars will be considered).

The process may include validating (at 730) the matching resources. Such validation may include, for example, validating any credentials via third-party resources. As another example, validation may include periodically comparing updated biometric information to previously supplied information. For instance, a user may have to update a biometric selfie once a year. As another example, a user may have to login to the LBS manager 100 using a fingerprint scan or other biometric data at regular intervals or within some specified time (e.g., the previous ninety days) in order to receive job notifications or bid on job postings.

As shown, process 700 may include providing (at 740) the job posting to the matching resources. As described above, the job posting may be sent to the matching resources via push messaging, using various communication channels such as text or email, etc. In some cases, job postings may be retrieved by the resources via a dedicated application or web-based interface associated with the LBS manager 100. In some embodiments, job postings may be applied to a map-based interface that indicates the job location.

Process 700 may include providing (at 750) communication channels between the job poster and matching resources. The communication channels may allow for text, voice, or multimedia communication between users. For instance, a poster-user 110 and resource 140 may discuss job details or changes to the job parameters (e.g., updates to schedule or price). In some embodiments, the process may provide communication channels among the resources 140. For instance, if a job is expected to be performed by multiple resources (e.g., bartenders and servers may both be requested for a cocktail party), the resources may be able communicate and/or jointly response to a job posting.

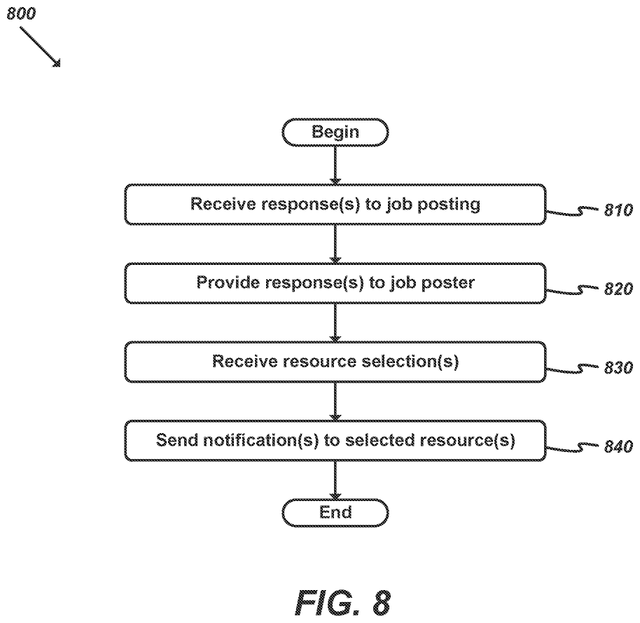

FIG. 8 illustrates an example process 800 for selecting resources to perform a job. Process 800 may be similar to the overview of FIG. 2 above. Process 800 may be performed after a job is posted. In some embodiments, process 800 may be performed by LBS manager 100.

As shown, process 800 may include receiving (at 810) responses to the job posting. Responses may be received from the various matching resources 140 and/or other qualified resources. Responses may include, for example, the responder resource ID or other reference that may be used to identify the responding resource 140 and/or associated resource record 150. Resource records 150 may be identified using a lookup table or other similar resource.

Process 800 may include providing (at 820) the responses to the job poster. Responses may be provided in various appropriate ways. For instance, the job poster may be able to view a table or listing of responses and may be able to sort or filter the listing in various ways, such as by price (if applicable), resource rating, number of jobs performed previously, qualifications or certifications, etc. As another example, each response may be forwarded to the job poster and the job poster may be able to accept or reject the offer.

The process may include receiving (at 830) one or more resource selection(s). Resource selections may be received in various appropriate ways. For example, as described above, a job poster may individually accept or reject each offer. As another example, the job poster may be able to select one or more responding resources from a listing of responses.

As shown, process 800 may include sending (at 840) notifications to the selected resource(s). In some cases notifications of rejection or non-selection may be provided (e.g., when a poster-user 110 rejects a response or finalizes selection or other resources). Notifications may be sent via push message, email, text, and/or other appropriate channels. In some cases, notifications may be stored and provided to resource-users 140 when the users next access the LBS manager 100 (e.g., by launching a dedicated application of some embodiments, by accessing a web portal associated with some embodiments, etc.).

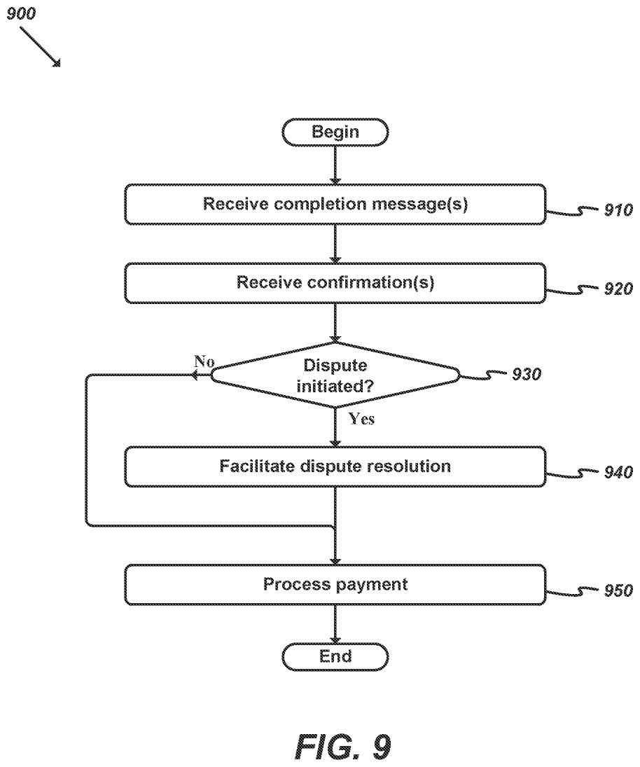

FIG. 9 illustrates an example process 900 for confirming job performance. Process 900 may be similar to the overview of FIG. 3 above. Process 900 may be performed after a job has been completed. In some embodiments, process 900 may be performed by LBS manager 100.

As shown, process 900 may include receiving (at 910) completion messages from the selected resource(s). A resource-user 140 may be able to select from among various status indicators associated with a job (e.g., “not started”, “in progress”, “on hold—issue identified”, “complete”, etc.). A resource-user 140 may indicate that a job is complete in various ways, such as selecting a “complete” option from a job-specific GUI. As another example, a resource-user 140 may send an email or other confirmation message that indicates the job has been completed and may be received by the LBS manager 100. In some cases, a job may automatically be marked or indicated as completed once a performance deadline is reached, unless a counter indication is received.

Process 900 may include receiving (at 920) confirmation(s) from the job poster. The process may send a notification or provide another indication that a resource has indicated the job is complete. In some cases, the scheduled completion time may trigger a message to the job poster. The confirmation may include or reference an indication from the job poster whether the job has been satisfactorily completed. Confirmation may depend on the type of services provided. For instance, if photography services are requested, the job poster 110 may select from among a set of images provided by the resource, thus indicating completion. Similarly, payment information and/or other job attributes may depend on such confirmation (e.g., the fee for photography services may be based on the number of pictures selected).

The process may include determining (at 930) whether a dispute has been initiated. The resource and/or job poster may be able to initiate a dispute when sending the completion or confirmation.

If process 900 determines (at 930) that a dispute has been initiated, the process may include facilitating (at 940) dispute resolution. Each dispute may include a proposed or acceptable resolution to the disputing party. For instance, if a resource discovers that the parameters of the job exceed those specified in the posting (e.g., a yard to be mowed is larger than indicated), the resource may specify an adjusted price that would be satisfactory. As another example, if the job poster does not feel the yard was mowed properly, the job poster may request the resource return to the job site to perform additional maintenance or may offer a reduced payment to resolve the dispute.

Process 900 may include processing (at 950) payment for the job. If the job is completed to both parties' satisfaction and/or any disputes have been resolved, payment may be processed. Such processing may include withdrawing funds from an account associated with the job poster and depositing the funds to an account associated with the resource. Payments may be processed using any appropriate available channels.

Process 900 may further update various profiles, records, and/or models based on the job posting, response, and performance. For instance, a resource record 150 may be updated to indicate that another job was completed and/or update a rating associated with the resource. As another example, matching models may be updated based on the resource selections made by a job poster (e.g., models may be updated to be more likely to identify resources that were selected and less likely to identify resources that were not selected).

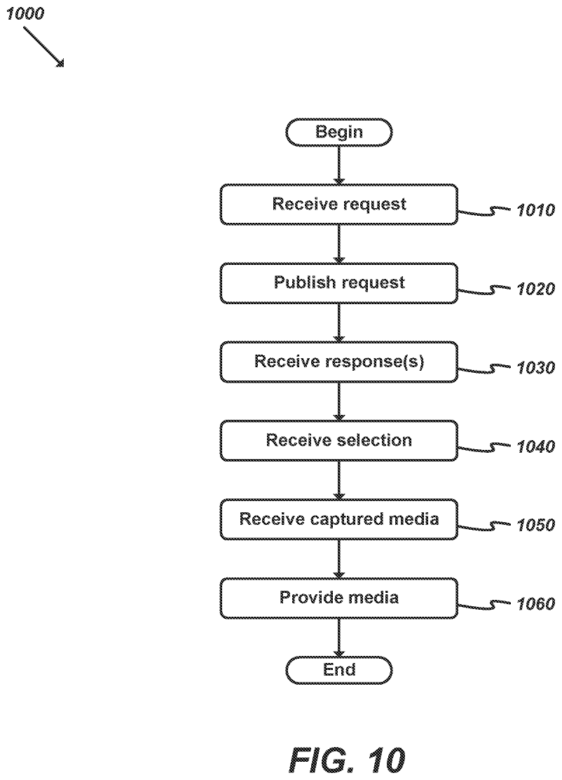

FIG. 10 illustrates a flow chart of an exemplary process 1000 that provides distributed surveillance. Such a process may be executed by a resource such as LBS manager 100. The process may begin, for instance, when a user launches an application of some embodiments.

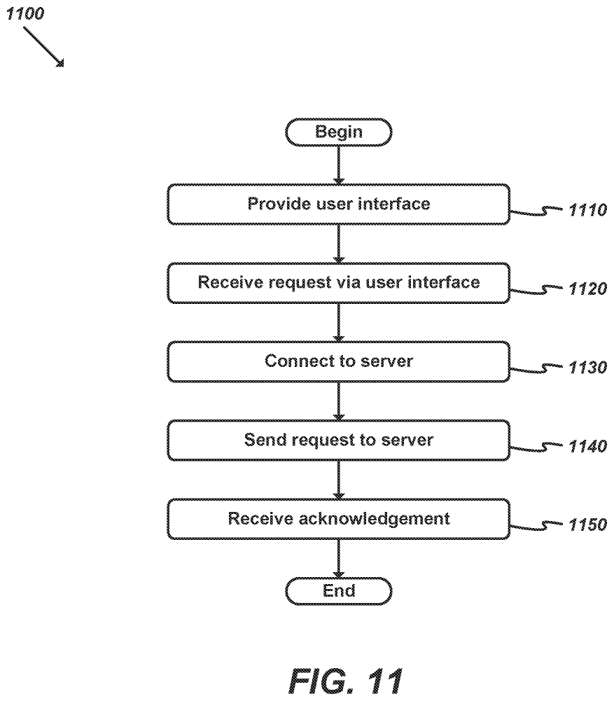

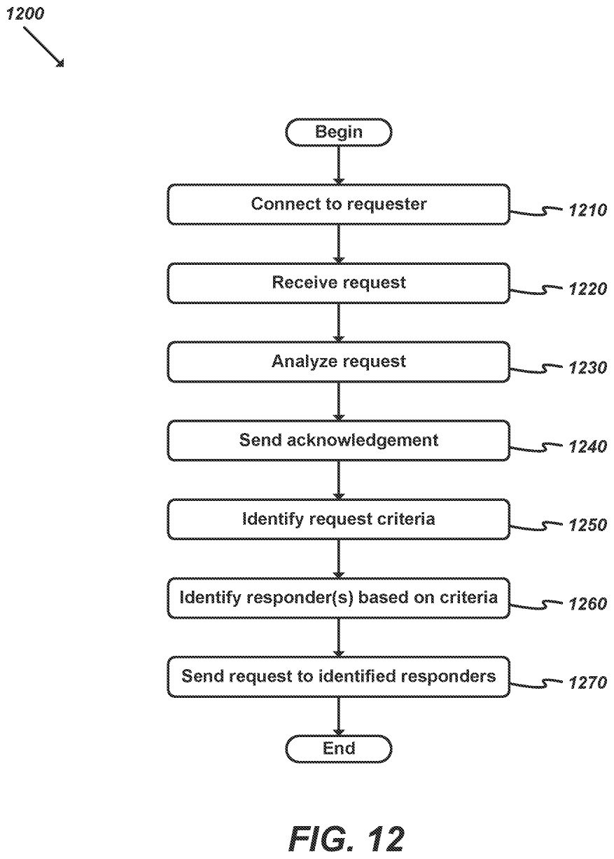

As shown, process 1000 may receive (at 1010) a task request. Such a request may be received via a requester device and passed to a server. The request may include various attributes, parameters, etc. For instance, the request may include a location, rate (i.e., an amount the requester is willing to pay for the service), a type (e.g., automobile, real estate, etc.), deadline, responder qualifications, and/or other appropriate information. Such request generation will be described in more detail below in reference to FIG. 11 and FIG. 12.

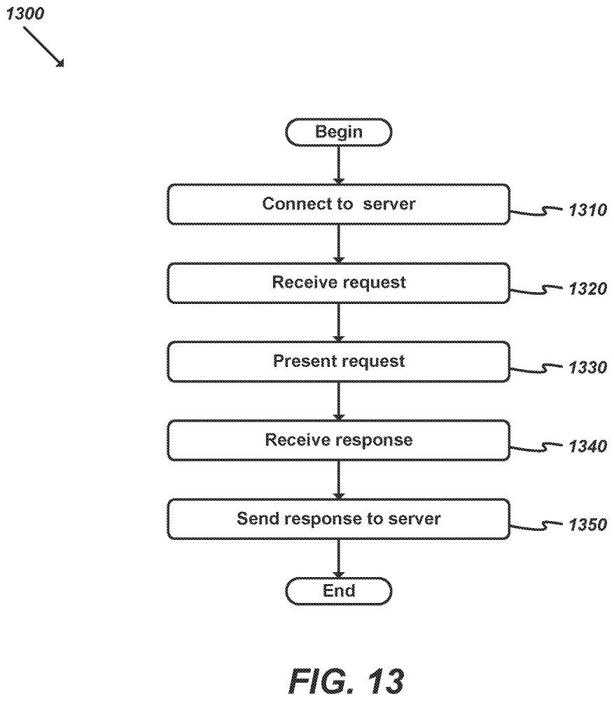

Next, the process may publish (at 1020) the request. Such publication may be made based on various appropriate criteria (e.g., type of request, location of users, etc.). The publication may include pushing the task to potential responders, making the task available for viewing by potential responders, etc. Some embodiments may identify potential responders from among a group of responder-users based on various appropriate criteria. Such criteria may be associated with the requester (e.g., location of request, experience level, etc.) and/or the responder (e.g., distance willing to travel, availability, etc.). Such request publication will be described in more detail in reference to FIG. 12 and FIG. 13.

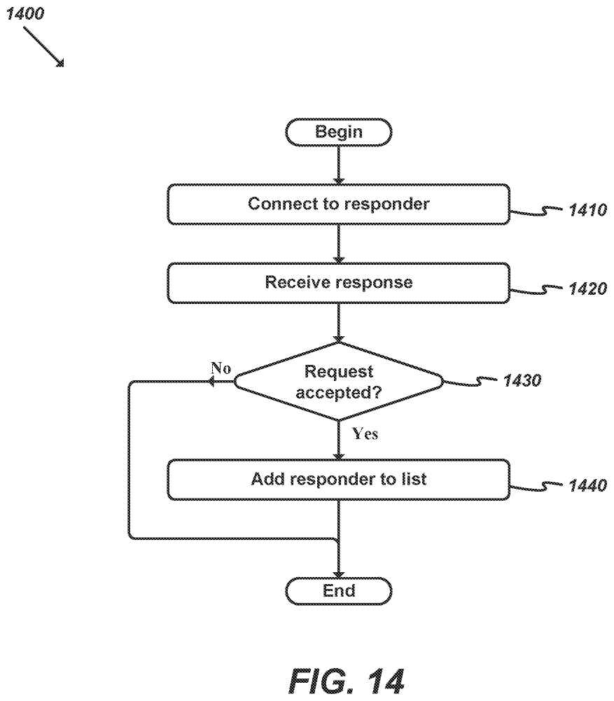

The process may then receive (at 1030) responses to the published request. Such responses may be received at the server via a responder device. The affirmative responses may be added to a candidate or potential responder list. Such response handling will be described in more detail below in reference to FIG. 13 and FIG. 14.

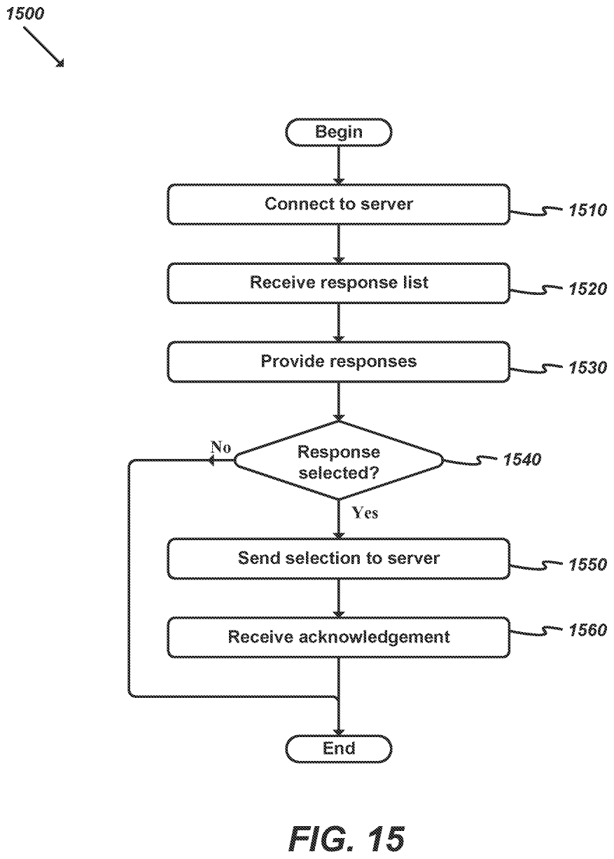

Next, the process may receive (at 1040) a selection from among the responders and assign the task to the selected responder. Such a selection may be made in various appropriate ways. For instance, some embodiments may send the list of candidates for review and selection by the requester. Alternatively, some embodiments may automatically select and assign a task to a responder. Such selection and assignment will be described in more detail below in reference to FIG. 15-FIG. 17.

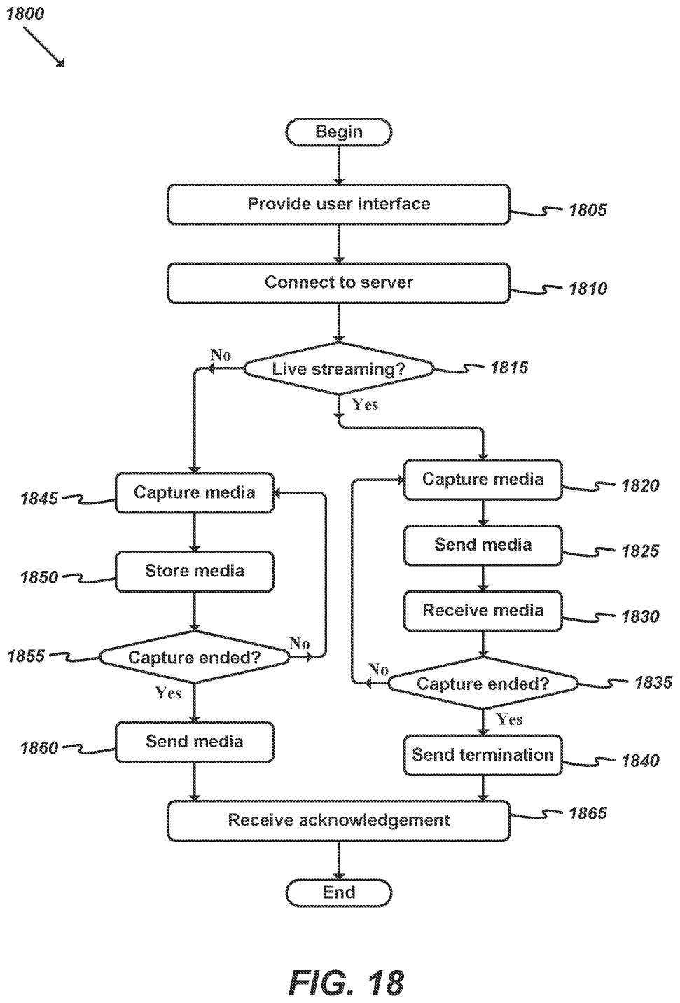

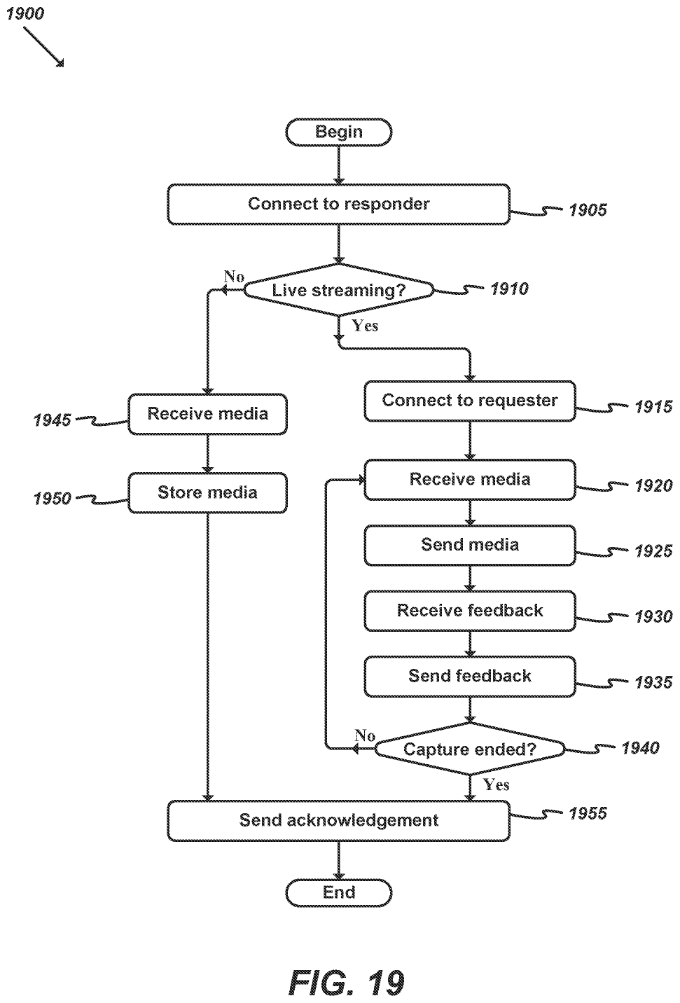

Process 1000 may then receive (at 1050) captured media from the responder. The media may be captured at a responder device. Depending on the type of capture/provision, the media may be provided to the requester in real time (e.g., as streaming video). Alternatively, the media may be stored and made available for later download and/playback by the requester. Some embodiments may relay the media via a server. Alternatively, the media may be sent from a responder device to a requester device without involving the server of some embodiments (e.g., via a peer-to-peer network). Such media capture will be described in more detail below in reference to FIG. 18 and FIG. 19.

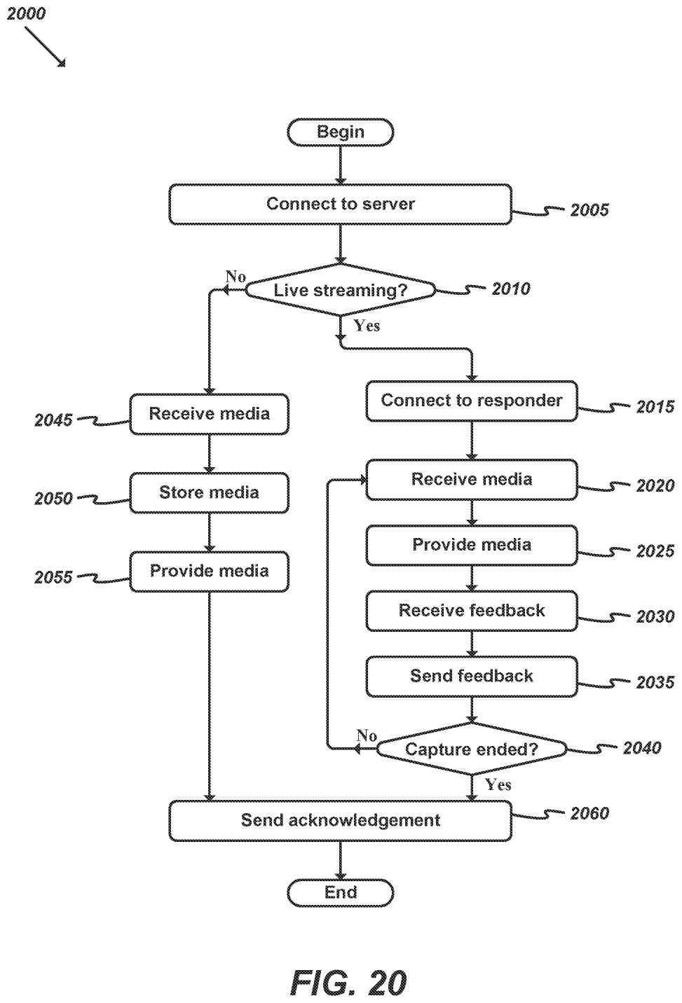

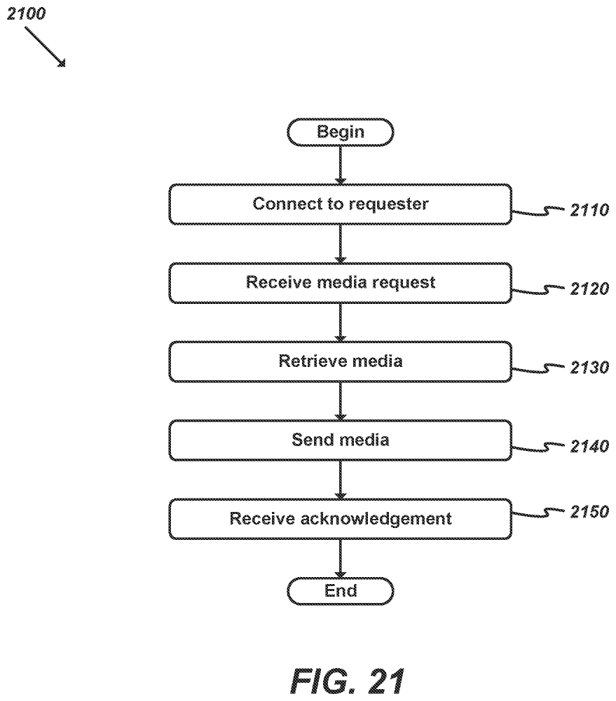

Finally, the process may provide (at 1060) the captured media to the requester and then may end. As above, in a real-time environment the media may be relayed from the responder device to the requester device. Alternatively, the requester may access the media (e.g., at the server) for download and/or playback after the event is complete. In addition to transferring media, other information or communication may be provided. For instance, a responder may be able to type in answers to various questions that may be associated with a request for services. As another example, some embodiments may allow two-way communication via voice, text, etc. during a real time session. Such media provision will be described in more detail below in reference to FIG. 20 and FIG. 21.

FIG. 11 illustrates a flow chart of an exemplary client-side process 1100 that receives surveillance requests. Such a process may be executed by a device such as user device 500 described above. The process may begin, for instance, when a user launches an application of some embodiments.

As shown, process 1100 may provide (at 1110) a user interface (UI). Such a user interface may be similar to the exemplary GUIs described below in Section IV. The UI may be provided via a user device app, a web browser, and/or other appropriate resource. The UI may include visual input/output elements (e.g., touchscreen elements), physical input/output elements (e.g., keypads, buttons, speakers, microphone, etc.), and/or other appropriate UI elements.

In this example, the UI is related to a requester generating a request for services. Other UIs may be provided based on relevant criteria (e.g., user type, user selections, default values, status, etc.).

Next, the process may receive (at 1120) a request via the UI. Such a request may include various attributes. Some attributes may be required (e.g., location, rate, etc.) while others may be optional or only applicable to certain types of requests (e.g., square footage of a house for a real estate review, specific options related to an automobile, etc.).

The process may then connect (at 1130) to the server. Such a connection may include various verification or confirmation operations. For instance, the user may have to supply a username and/or password when launching the app, when a request is sent to the server, etc. In addition, the client device and server may send various handshake or other messages in order to establish a communication channel. Such messaging and/or interface requirements may depend on the type(s) of devices, available communication pathway(s), and/or other relevant factors.

Process 1100 then may send (at 1140) the request to the server, receive (at 1150) an acknowledgement from the server, and then may end. The request may include the information provided by the requester, information related to the user or user account, and/or other appropriate information. The acknowledgement may include an acceptance or validation element or flag and/or other appropriate information.

FIG. 12 illustrates a flow chart of an exemplary server-side process 1200 that receives surveillance requests. Process 1200 may be complementary to a process such as process 1100 described above. A process such as process 1200 may be executed by a device such as

LBS manager 100 or server 430 described above. The process may begin, for instance, when a user device sends a connection request to the server.

As shown, process 1200 may connect (at 1210) to the requester. Such a connection may be made in a similar way to that described in reference to operation 1130 above. Next, the process may receive (at 1220) a request for a task. The process may then analyze (at 1230) the request and send (at 1240) a response based on the analysis. The analysis may include determining whether the request is complete, valid, or otherwise satisfies some submission criteria. The acknowledgement may include a receipt acknowledgement, and indication of identified issues or errors, and/or other appropriate information.

The process may then identify (at 1250) the request criteria based on the analysis. The request criteria may include, for instance, proximity, availability, rate, type, etc. Next, the process may identify (at 1260) potential responders based on the criteria. For instance, responders may be able to specify that they are only interested in certain types of jobs (e.g., automobile inspections only), will only travel to certain areas, schedule of availability, etc. Responders that fail to satisfy some criteria may not be added to a list of potential responders (or may be removed from such a list).

Finally, the process may send (at 1270) the request to the identified potential responders and then may end. The request may be sent as a push message via an app on the responder mobile device. Alternatively, messages may be made available for retrieval and sent when a request is made by the responder.

FIG. 13 illustrates a flow chart of an exemplary client-side process 1300 that presents surveillance requests to potential responders. Such a process may be executed by a device such as user device 500 described above. The process may begin, for instance, when a user launches an application of some embodiments.

As shown, process 1300 may connect (at 1310) to the server and receive (at 1320) a request. As above, in some embodiments the request may be automatically received as a push message.

Next, the process may present (at 1330) the request. Such a request may be presented via an appropriate UI. Some such example UIs will be described in more detail in Section IV below.

The process may then receive (at 1340) a response to the request. Such a response may include an indication (e.g., apply or accept, decline, etc.) and/or other appropriate information (e.g., expected completion date, requests for additional information, etc.).

Finally, the process may send (at 1350) the response to the server and then may end.

FIG. 14 illustrates a flow chart of an exemplary server-side process 1400 that receives responses to surveillance requests from. Process 1400 may be complementary to a process such as process 1300 described above. A process such as process 1400 may be executed by a device such as LBS manager 100 or server 430 described above. The process may begin, for instance, when a user device sends a connection request to the server.

As shown, process 1400 may connect (at 1410) to the responder and receive (at 1420) a response. As above, the response may include an indicator and/or other information.

Next, the process may determine (at 1430) whether the request was accepted. Such a determination may be made based on the indicator from the received response.

If the process determines the request was not accepted, the process may end. If the process determines that the request was accepted, the process may add (at 1440) the responder to the list and then may end.

FIG. 15 illustrates a flow chart of an exemplary client-side process 1500 that receives response selections from requesters. Such a process may be executed by a device such as user device 500 described above. The process may begin, for instance, when a user with an active request launches an application of some embodiments.

As shown, process 1500 connect (at 1510) to the server and receive (at 1520) the response list. The response list may include all responder who have submitted an affirmative response regarding the request. The responses may be provided (at 1530) to the requester via an appropriate UI, such as the exemplary GUIs described below in Section IV.

Next, the process may determine (at 1540) whether a response (and associated responder) has been selected by the requester. Such a selection may be made in various appropriate ways (e.g., selecting a specific responder from a list, affirming a single responder, etc.).

If the process determines that a response has been selected, the process may then send (at 1550) the selection to the server, receive (at 1560) an acknowledgement and then may end. If the process determines (at 1540) that no response has been selected, the process may end.

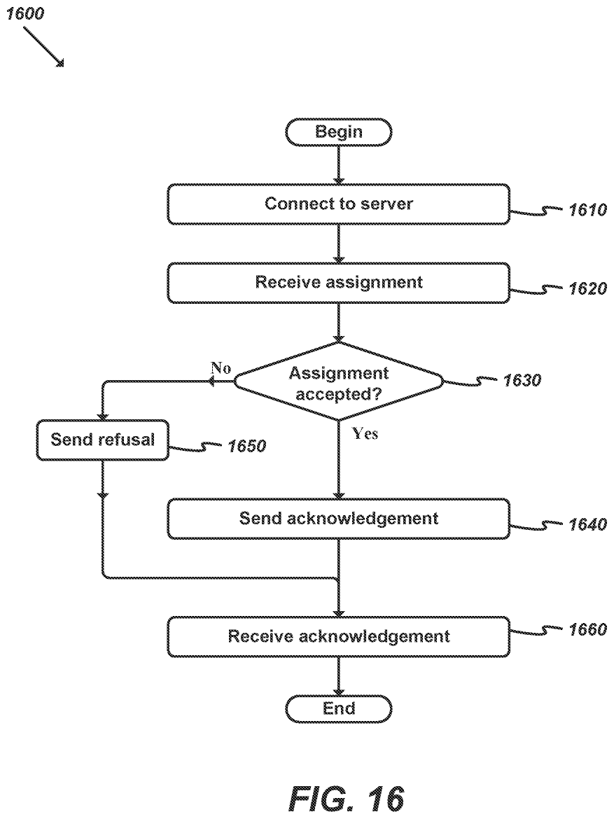

FIG. 16 illustrates a flow chart of an exemplary client-side process 1600 that presents assignments to responders. Such a process may be executed by a device such as user device 500 described above. The process may begin, for instance, when a user associated with an accepted response launches an application of some embodiments.

As shown, process 1600 may connect (at 1610) to the server and receive (at 1620 any assignments. Such assignments may be sent as push notifications, retrieved when the app is launched, and/or otherwise sent.

Next, the process may determine (at 1630) whether the potential responder has accepted the assignment. Such a determination may be made based on various relevant factors (e.g., inputs received from the responder). If the process determines that the potential responder has accepted the assignment, the process may send (at 1640) an acknowledgement message. If the process determines (at 1630) that the assignment was not accepted, the process may send (at 1650) a refusal message.

Process 1600 may then receive (at 1660) an acknowledgement of the acceptance or refusal and then may end.

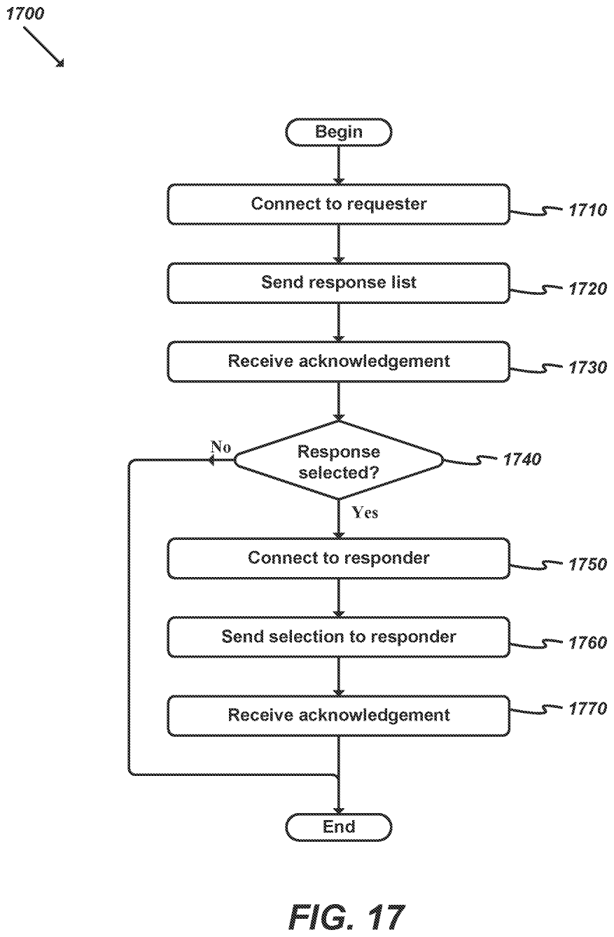

FIG. 17 illustrates a flow chart of an exemplary server-side process 1700 that receives response selections from requesters and sends assignments to selected responders. Process 1700 may be complementary to a process such as process 1600 and/or process 1500 described above. A process such as process 1700 may be executed by a device such as LBS manager 100 or server 430 described above. The process may begin, for instance, when a user device sends a connection request to the server.

As shown, process 1700 may connect (at 1710) to a requester. Next, the process may send (at 1720) a response list for any open assignments requested by the requester. The process may then receive (at 1730) an acknowledgement message from the requester device.

Next, the process may determine (at 1740) whether a response (and associated responder) has been selected. Such a selection may be made based on various relevant factors (use selections, default settings, etc.). If the process determines that no response has been selected, the process may end.

If the process determines that a response has been selected, the process may connect (at 1750) to the selected responder, send (at 1760) a selection notification to the responder device, receive (at 1770) acknowledgment from the responder and then may end.

FIG. 18 illustrates a flow chart of an exemplary client-side process 1800 that captures and processes media for a responder. Such a process may be executed by a device such as user device 500 described above. The process may begin, for instance, when a user launches an application of some embodiments.

As shown, process 1800 may provide (at 1805) a UI. Such a user interface may include various appropriate elements for capturing media (e.g., a viewfinder, record controls, etc.). In addition, such an interface may allow two-way communication with a requester during live streaming. Next, the process may connect (at 1810) to the server.

The process may then determine (at 1815) whether the session will be live. Such a determination may be made based on various relevant factors (e.g., availability of the requester, quality of network connection, etc.).

If the process determines that the session will be live streaming, the process may then capture (at 1820) the media. Such media capture may involve, for instance, using a device camera to capture video or still images. In addition, some embodiments may capture communications from the responder (e.g., text, voice, etc.) for transmission to the requester.

The process may then send (at 1825) the captured media. In some embodiments the media may be sent to the server for further distribution to the requester. Alternatively, the captured media may be sent over a P2P channel.

Next, the process may receive (at 1830) media. Such media may include, for instance, text or voice communications from the requester.

The process may then determine (at 1835) whether the capture has ended. Such a determination may be made based on various relevant factors (e.g., selection of a “stop” button by the responder, termination of the session by the responder or requester, etc.). The process may repeat operations 1820-1835 until the process determines (at 1835) that capture has ended. Process 1800 may then send (at 1840) a termination notification to the server and/or requester.

If the process determines (at 1815) that live streaming will not be used, the process may capture (at 1845) and store (at 1850) the media. The media may be stored locally at the capture device and/or may be transmitted to the server (at time of capture or at a later time, such as when a connection is available).

Next, the process may determine (at 1855) whether the capture has ended. The process may repeat operations 1845-1855 until the process determines (at 1855) that capture has ended. The process may then send (at 1860) the captured media to the server and/or requester.

After sending (at 1840) a termination message or after sending (at 1860) the captured media, the process may receive (at 1865) an acknowledgement message from the server or requester device and then may end.

FIG. 19 illustrates a flow chart of an exemplary server-side process 1900 that captures and processes media from a responder. Process 1900 may be complementary to a process such as process 1800 described above. A process such as process 1900 may be executed by a device such as LBS manager 100 or server 430 described above. The process may begin, for instance, when a user device sends a request to deliver captured media.

As shown, process 1900 may connect (at 1905) to a responder. Next, the process may determine (at 1910) whether the session will be live streaming. If the process determines that the session will be live, the process may connect (at 1915) to the requester.

Process 1900 may then receive (at 1920) captured media from the responder and send (at 1925) the media to the requester. Next, the process may receive (at 1930) feedback from the requester and send (at 1935) the feedback to the responder. The process may then determine (at 1940) whether capture has ended. The process may repeat operations 1920-1940 until the process determines (at 1940) that capture has ended.

If the process determines (at 1910) that the session will not be live, the process may receive (at 1945) the captured media and store (at 1950) the received media for later delivery to the requester.

After determining (at 1940) that capture has ended or after storing (at 1950) the media, the process may send (at 1955) acknowledgement messages to the responder and/or requester, as appropriate, and then may end.

FIG. 20 illustrates a flow chart of an exemplary client-side process 2000 that retrieves and presents media to a requester. Such a process may be executed by a device such as user device 500 described above. The process may begin, for instance, when a user launches an application of some embodiments.

As shown, process 2000 may connect (at 2005) to the server. Next, the process may determine (at 2010) whether the session is live streaming. If the process determines that the session is live, the process connect (at 2015) to the responder.

Next, the process may receive (at 2020) captured media and provide (at 2025) the media to the requester (e.g., by displaying video content). Such captured media may include communications from the responder. The process may then receive (at 2030) feedback from the requester, if any and send (at 2035) the feedback to the responder.

Process 2000 may then determine (at 2040) whether the capture has ended. If the process determines that capture has not ended, the process may repeat operations 2015-2040 until the process determines (at 2040) that capture has ended.

If the process determines (at 2010) that the session is not live streaming, the process may receive (at 2045) the media. Such media may be retrieved from the server or from the storage via an API. Next, the process may store (at 2050) the received media. Alternatively, some embodiments may deliver the stored media as a stream that does not require the user to download a complete file. The process may then provide (at 2055) the media to the requester (e.g., by launching a media player or within the app of some embodiments).

After providing (at 2055) the media or determining (at 2040) that capture has ended, the process may send (at 2060) acknowledgement messages to the server and/or responder device and then may end.

FIG. 21 illustrates a flow chart of an exemplary server-side process 2100 that retrieves and provides media to a requester. Process 2100 may be complementary to a process such as process 2000 described above. In a streaming implementation, process 1900 may be complementary to a process such as process 2000. A process such as process 21500 may be executed by a device such as LBS manager 100 or server 430 described above. The process may begin, for instance, when a user device sends a media request to the server.

As shown, process 2100 may connect (at 2110) to the requester. Next, the process may receive (at 2120) a media request for media associated with an assignment.

The process may then retrieve (at 2130) the requested media and send (at 2140) the requested media to the requester. Next, the process may receive (at 2150) an acknowledgement or termination message and then may end.

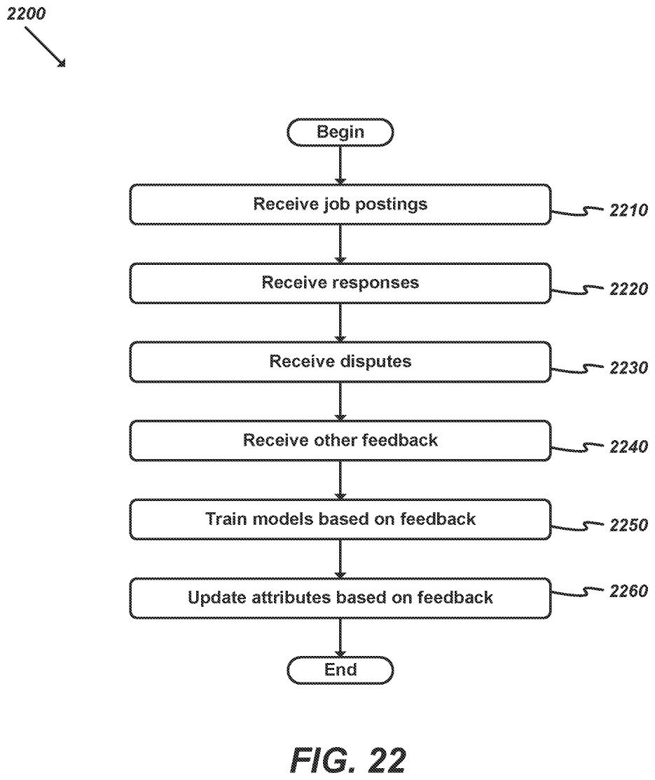

FIG. 22 illustrates an example process 2200 for implementing machine learning. The process may be used to train models associated with resource matching, user validation, dispute resolution, and/or other features provided by LBS manager 100. The process may be performed at regular intervals, when training data becomes available, and/or other under other appropriate conditions. In some embodiments, process 2200 may be performed by LBS manager 100.

As shown, process 2200 may include receiving (at 2210) job postings. For instance, job posting records 130 may be retrieved from a resource such as storage 440. The received job postings may be filtered based on various appropriate criteria. For instance, job postings may be filtered based on category, sub-category, job type, required qualifications, geographic region, etc.

Process 2200 may include receiving (at 2220) responses associated with the job postings. Such responses may include listings of messages submitted in response to a job posting, where the messages may indicate the resource ID, response parameters (e.g., price or schedule estimate), etc.

The process may include receiving (at 2230) disputes associated with the job postings. Dispute information and/or satisfactory completion information may be received from a resource such as storage 440.

As shown, process 2200 may include receiving (at 2240) other feedback. Other feedback may include, for instance, performance ratings (e.g., ratings of resources by job posters, ratings of job posters by resources, etc.). Other feedback may include feedback related to incomplete jobs. For example, if a poster-user 110 does not receive any responses or does not accept any received responses, such a result may be included as other feedback. Other feedback may include administrator evaluations of suggestions or identified matching resources (e.g., an administrator may review matching resources identified by the LBS manager 100 and indicated whether each resource was relevant and/or appropriate).

The process may include training (at 2250) models based on the received feedback.

Such training may include use of various machine learning models, algorithms, AI features, etc. For instance, some embodiments may utilize a recurrent neural network (RNN) to train the models and/or rules of some embodiments. The new or updated models may be provided to the LBS manager 100. In some embodiments, models associated with individual users may be trained. For instance, if a particular resource never responds to job postings from a particular area within the specified service location, the service location may be updated to exclude the particular area.

As shown, process 2200 may include updating (at 2260) attributes based on the feedback. For example, job categories and/or sub-categories may be updated based on the received feedback and/or other analysis (e.g., job categories that are rarely or never selected may be removed, while a category or sub-category that is selected often may be divided into multiple sub-categories).

One of ordinary skill in the art will recognize that the processes described above may be implemented in various different ways without departing from the scope of the disclosure. For instance, the various operations may be performed in different sequences, some listed operations may be omitted, and/or some additional operations may be included. In addition, the processes (and/or portions thereof) may be performed iteratively and/or based on some specified criteria. Furthermore, each process may be included as part of a larger macro process or divided into multiple sub-processes.

For instance, some embodiments may provide processes that allow for billing, payment, etc. to be managed during jobs and/or after completion. As another example, various processes may be used to authenticate or validate users before access to some elements is provided.

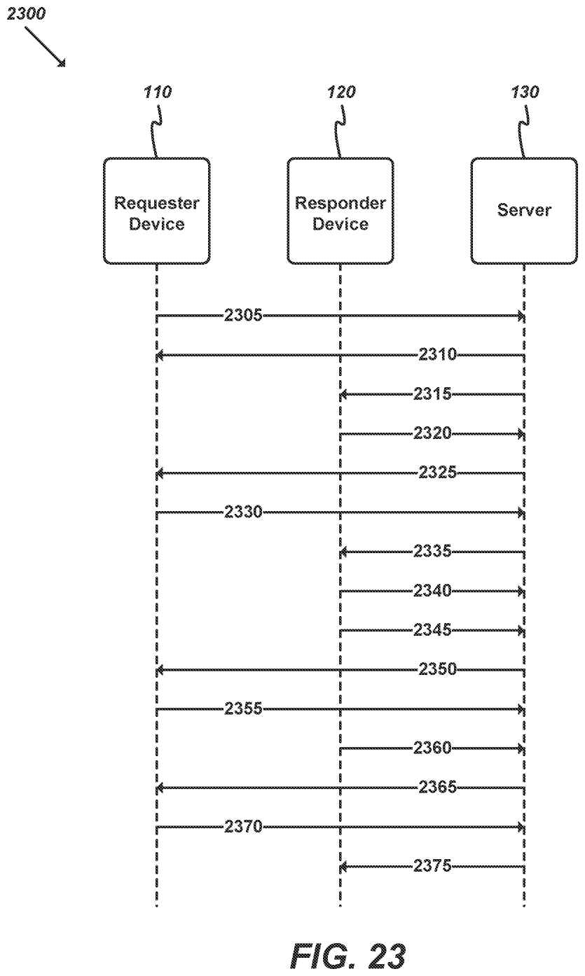

FIG. 23 illustrates a message flow diagram of an exemplary communication algorithm 2300. The diagram include a requester device 410, a responder device 420, and a server 430, as shown.

As shown, the requester device may send an assignment request message 2305 to the server. Such a message may include information related to an assignment (e.g., type, rate, location, etc.). Next, the requester 410 may receive a confirmation or acknowledgement message 2310 from the server 430.

The server may then send a request message 2315 to the responder 420 and receive an acknowledgement message 2320. Messages 2315-2320 may be repeated for multiple potential responders.

Next, the server 430 may send a candidate list message 2325 to the requester 410. The requester may respond with a candidate selection message 2330.

Based on the received selection, the server 430 may send an assignment message 2335 to the responder 420 and receive an acknowledgement message 2340 accepting the assignment.’

Next, the responder 420 may send a capture ready message 2345 when capture is about to begin. The server 430 may, in turn, send a connection message 2350 to the requester 410 if the session is to be live streaming. The requester may respond with an acknowledgement message 2355 to the server 430 indicating whether the requester 410 is ready for streaming. For cases where the content is to be stored and retrieved at a later time, messages 2350 and 2355 may be omitted.

Next, the responder 420 may transmit captured media 2360 to the server 430. If the session is not live, the server may simply store the received media. If the session is live, the server may transmit the captured media 2365 to the requester 410. The requester may send feedback 2370, as appropriate. Finally, the server may relay the feedback 2375 to the responder 420. Operations 2360-1575 may be repeated until the session is terminated.

One of ordinary skill in the art will recognize that different embodiments may use different specific messages and/or sequences of messages. Such algorithms may be depend on various user actions or selections (e.g., whether session will be live or not). In addition, although various messages have been represented as single entities flowing in a single direction, one of ordinary skill would recognize that each message show in FIG. 23 may be implemented using multiple messages that may be transmitted back and forth between the appropriate resources (and/or other additional resources).

### IV. Usage Scenarios

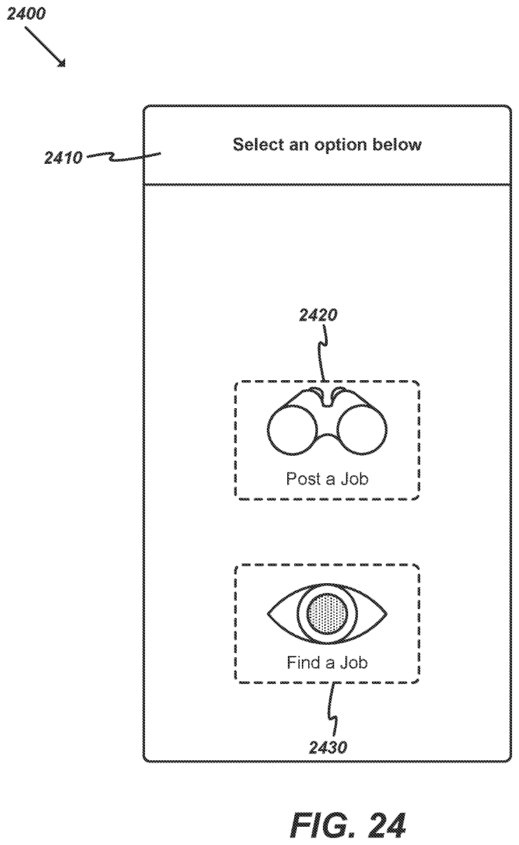

FIG. 24 illustrates an exemplary GUI 2400 that presents surveillance options to users. Such an interface may be invoked, for instance, when an application of some embodiments is launched. As shown, this example interface may include a title or direction 2410, and various options 2420-2430 associated with various types of users. In some embodiments, a selection may be made automatically. For instance, a user may specify that the user is only interested in finding jobs and not posting jobs.

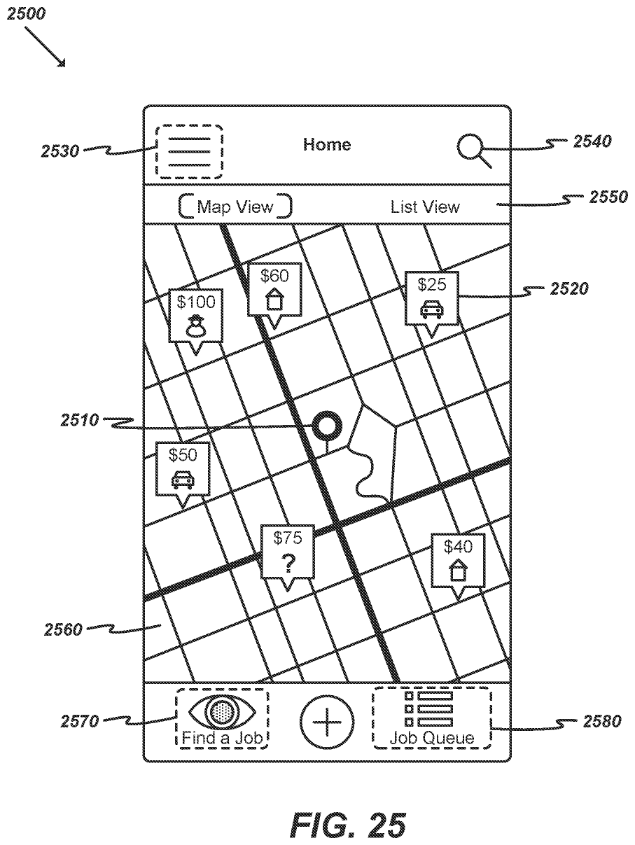

FIG. 25 illustrates an exemplary GUI 2500 that presents requests to potential responders using a map-based view. Such an interface may be invoked, for instance, by selecting an element such as object 2430 described above. As shown, this example interface 2500 may include a location marker 2510, various open tasks 2520, a setting selector 2530, a search element 2540, a view selector 2550, a map background 2560, a find a job button 2570, and a job queue selector 2580.

The location marker 2510 may indicate the current location of the user relative to the map 2560. Each open task indicator 2520 may include an icon or other type indicator, a compensation amount or rate, and/or other appropriate information. The open task indicators may be selectable, allowing a user to press the indicator to open the task.

The setting selector 2530, search element 2540 and/or other such elements may allow a user to invoke a drop-down menu or other appropriate selector or indicator or activate other appropriate GUI elements (e.g., a search box).

The view selector 2550 may allow a user to select from among various types of views.

The map background 2560 may include map information for the surrounding area.

Various other buttons and selectors such as a browse jobs feature 2570, job queue selector 2580, and/or other appropriate elements may be included (e.g., add project).

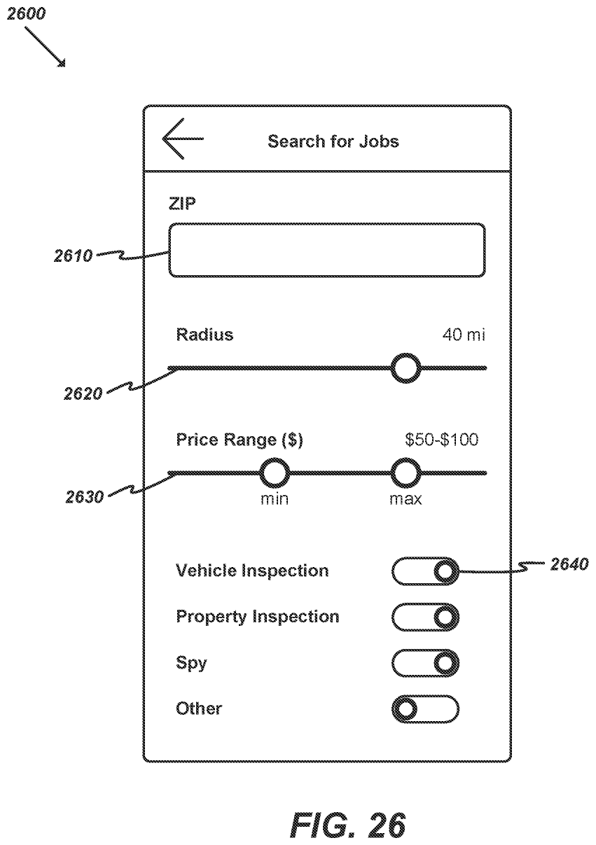

FIG. 26 illustrates an exemplary GUI 2600 that allows responders to search for available requests. Such an interface may be invoked, for instance, when an object such as option 2570 described above is selected or otherwise activated. As shown, the GUI 2600 may include a location entry block 2610, an availability radius selector 2620, a price range selector 2630, and various feature enable sliders 2640.

The location entry block 2610 may allow a user to set a location for a prospective task. The location may be set in various appropriate ways (e.g., typing a city and state, ZIP code, neighborhood, etc.). In some embodiments, the location entry block may automatically identify a location of the user (e.g., using GPS).

The radius slider 2620 and price range slider 2630, among other possible range selectors, may be used to select within various available ranges or thresholds. Different embodiments may allow users to set various different values, flags, etc. for various different parameters.

The enable/disable sliders 2640 may be used to activate and/or deactivate various features or attributes. In this example, the user may indicate the types of jobs the user may be interested in performing.

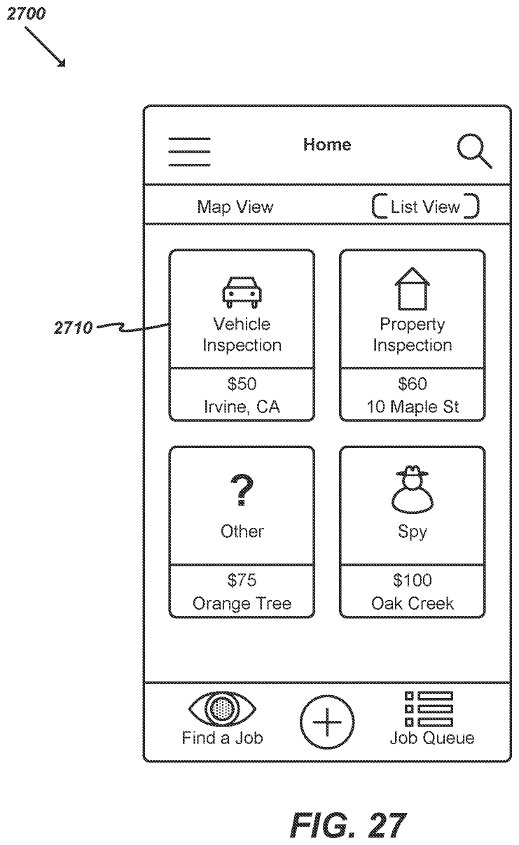

FIG. 27 illustrates an exemplary GUI 2700 that presents requests to potential responders using a list-based view. Such a GUI may be invoked, for instance, when a selection of “list view” is received via element 2550 described above. As shown, this example interface 2700 includes various tiles 2710 representing the potential tasks.

Each tile 2710 may include information related to the job type, rate, location, etc. Such tiles may be selectable (e.g., a user may be able to press a tile to select that job).

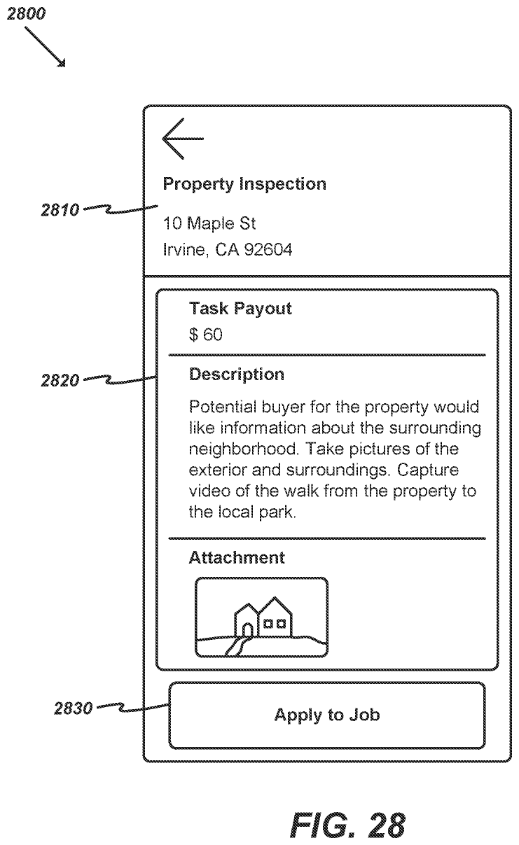

FIG. 28 illustrates an exemplary GUI 2800 that presents a request to a potential responder. Such a GUI may be invoked by selecting an element such as indicator 2520 or one of the tiles 2710 described above. As shown, the GUI 2800 may include a demographic information field 2810, a task description tile 2820, and a task application button 2830.

The information field 2810 may include various appropriate elements (e.g., type of project, location, etc.).

The description tile 2820 may include various descriptive elements related to the job (e.g., payout, description, etc.). In this example, the description tile includes a photo attachment. Such a photo may be used to help identify the property or person to be viewed. Different jobs may allow different types or numbers of attachments.

The task application button 2830 may allow a responder to apply for the given task.

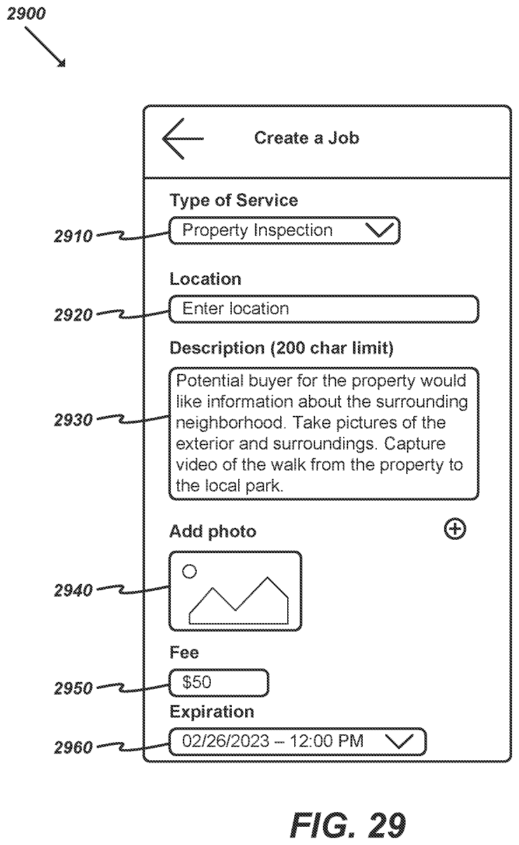

FIG. 29 illustrates an exemplary GUI that generates a request. Such an interface may be invoked, for instance, by selecting an element such as object 2420 described above. As shown, this example interface 2900 may include a type selector 2910, location entry box 2920, description entry box 2930, attachment feature 2940, fee input element 2950, and an expiration selector 2960.

The various elements 2910-2960 may allow text entry, selection from among a set of options, etc., as appropriate, based on the specific parameter (e.g., types of jobs may be limited to specific options, while a description may allow for many specific arrangements of characters, a fee may be limited to a specified range, etc.) and/or other relevant factors (e.g., user history, default options, user selections, etc.).

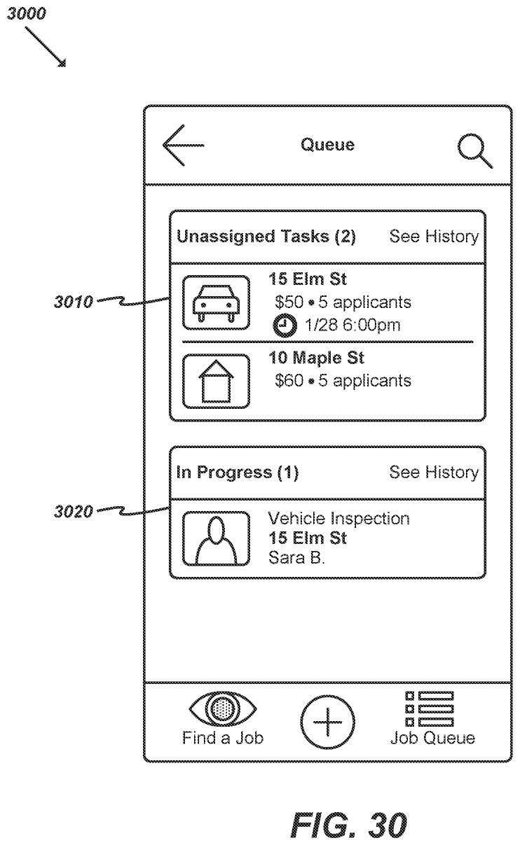

FIG. 30 illustrates an exemplary GUI 3000 that presents a queue to a requester. Such a GUI may be invoked, for instance, when a job is created using GUI 2900, when a selection of an element such as element 2580 is received, and/or under other appropriate conditions (e.g., a requester launches an app of some embodiments, when a user has unassigned tasks, etc.). This example interface 3000 includes a tile 3010 with two unassigned tasks and a tile 3020 with one assigned, in progress task.

This example GUI may allow a requester to see a summary of all tasks, review number of responses, view deadlines, etc.

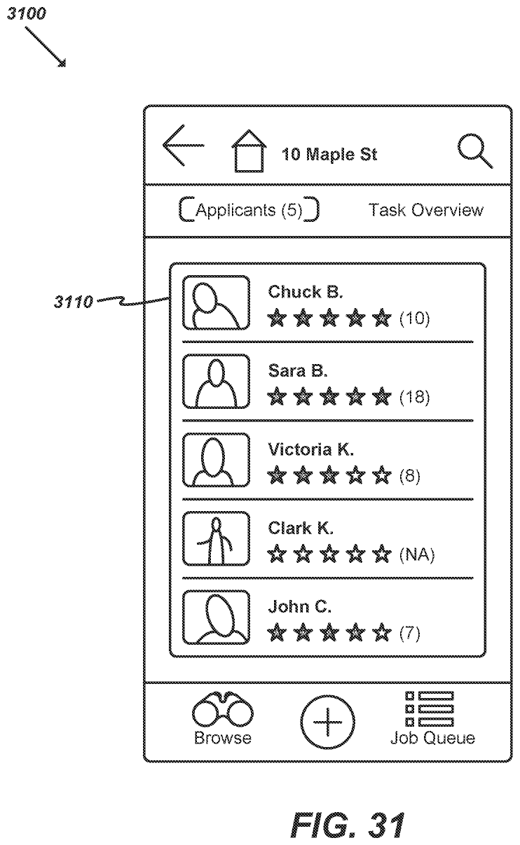

FIG. 31 illustrates an exemplary GUI 3100 that provides a list of responders to a requester. Such a GUI may be invoked, for instance, by selecting an unassigned task using interface element 3010 described above. As shown, the GUI 3100 may include a tile 3110 listing the various applicants (and/or potential applicants) for a job.

The tile 3110 may include information for each candidate or applicant, such as a photo, name or alias, rating, etc. Some applicants may be presented based on specific actions (e.g., a responder applies for a job) or bases on some evaluation criteria (e.g., all active users that serve the specified location may be listed as potential applicants).

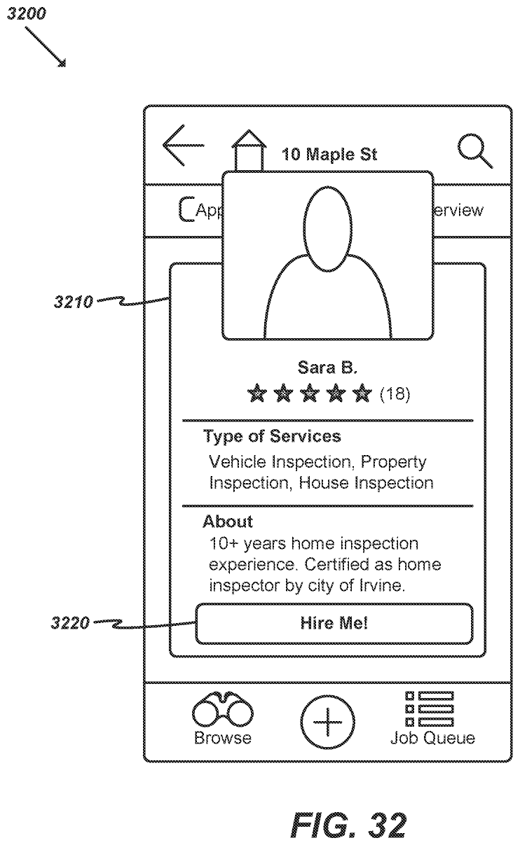

FIG. 32 illustrates an exemplary GUI 3200 that provides information regarding a particular responder. Such a GUI may be invoked, for instance, by selecting a potential responder using interface element 3110 described above. As shown, the GUI 3200 may include a responder tile 3210, and a selection button 3220.

The responder information tile 3210 may include information related to the responder, such as name or alias, photo, rating, types of services offered, biographic information, reviews of previous jobs, etc.

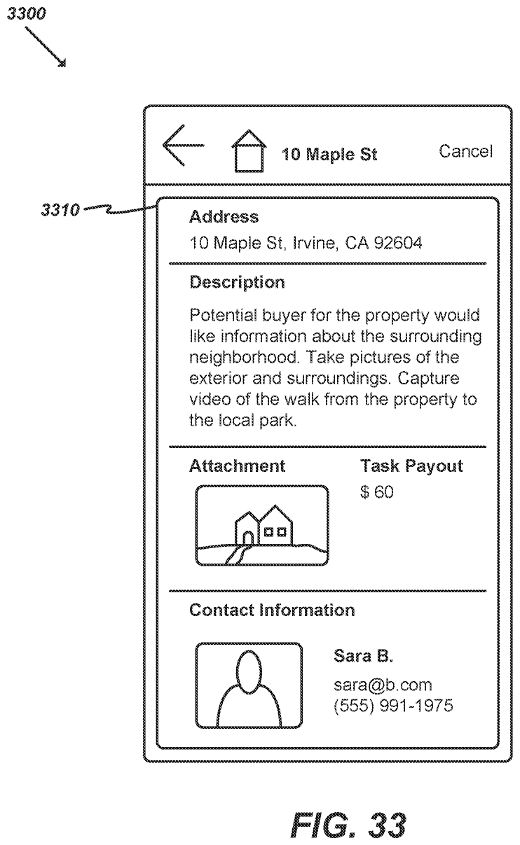

FIG. 33 illustrates an exemplary GUI 3300 that provides information regarding a request after a responder has been selected. Such an interface may be invoked, for instance, by selecting an element such as object 3220 described above. As shown, the GUI 3300 may include a task summary tile 3310.

The task summary tile 3310 may include information related to the task and assigned responder (when viewed by a requester). A similar tile may include information related to the requester (when viewed by a responder). In some embodiments, after media has been captured, a requester may access the media from a similar GUI.

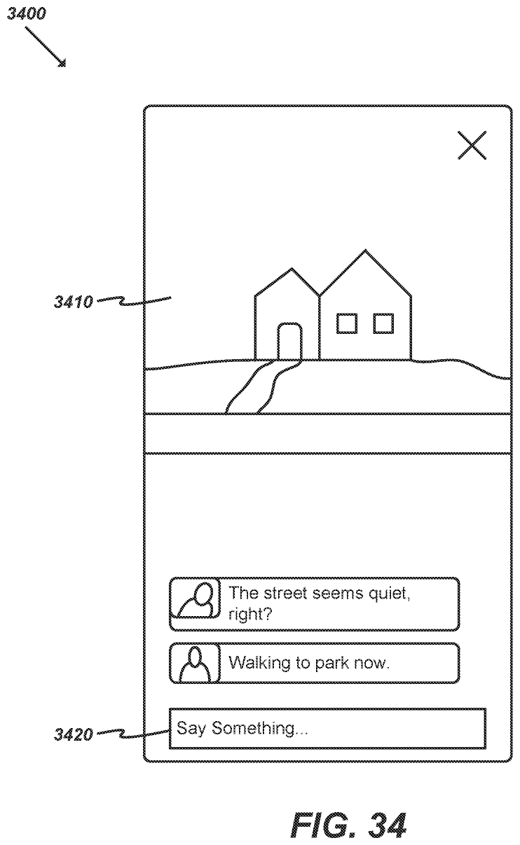

FIG. 34 illustrates an exemplary GUI 3400 that provides streaming surveillance between a responder and a requester. Such a GUI may be invoked, for instance, when a selected responder indicates that the responder is available (e.g., for a two-way session), when the responder selects a capture or start session option (e.g., for a recorded media session), and/or based on other appropriate criteria. As shown, this GUI may include a media display area 3410 and a communication interface 3420.

The media display area 3410 may allow a requester to view streaming content captured by the responder. The responder may be provided with a similar GUI.

The communication interface 3420 in this example, allows two-way text-based communication between the requester and the responder. In this way, the requester may ask for additional information, different perspective views, different zoom level, etc. For recorded sessions, the communication interface may be modified or eliminated. For instance, in some embodiments a responder may be able to enter information regarding the session. For recorded sessions, the communication interface may be modified or eliminated. For instance, in some embodiments a responder may be able to enter information regarding the session. Some embodiments may further allow for information to be provided via multimedia (e.g., by recording audio associated with a session).

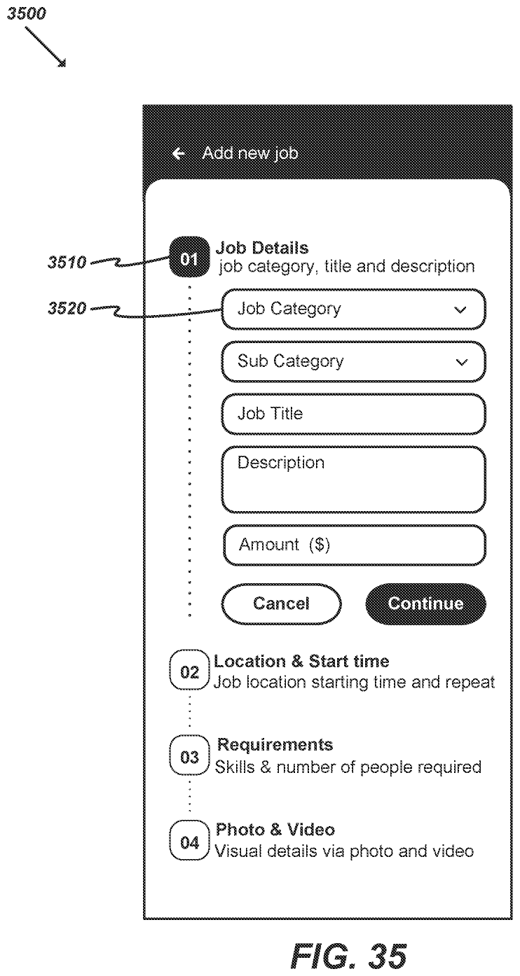

FIG. 35 illustrates an exemplary GUI 3500 that receives job posting information.

Such an interface may be invoked, for instance, by selecting an element such as object 2420 described above. As shown, GUI 3500 may include various job attribute sections 3510 associated with various selection or input elements 3520.

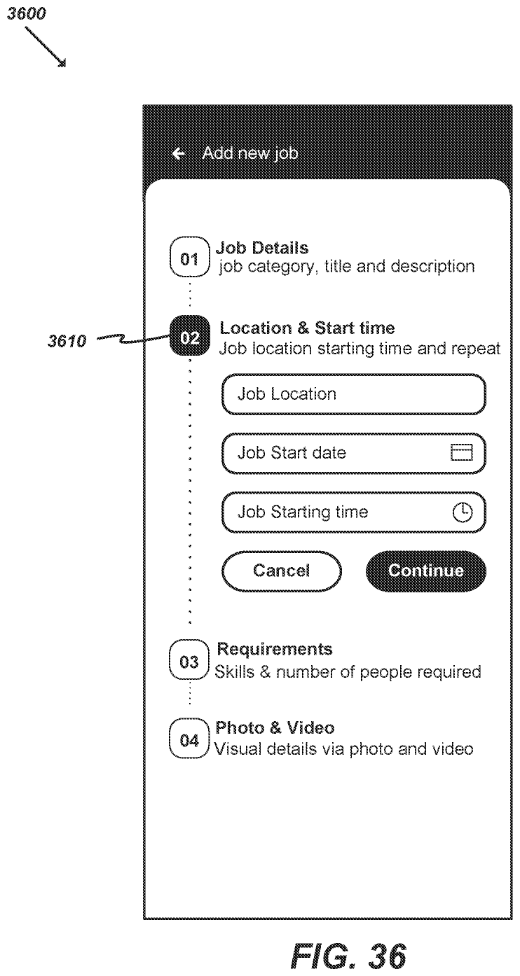

FIG. 36 illustrates an exemplary GUI 3600 that receives job scheduling information. Such a GUI may be invoked, for instance, by selecting element 3610. As shown, GUI 3600 may include inputs related to location, start time and date, etc.

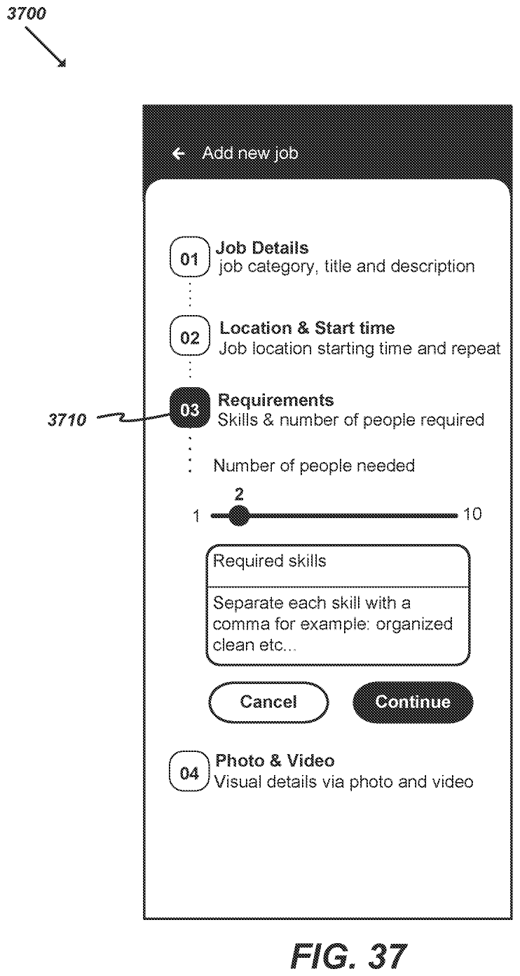

FIG. 37 illustrates an exemplary GUI 3700 that receives job requirement information. Such a GUI may be invoked, for instance, by selecting an element such as object 3710. As shown, GUI 3700 may include elements for receiving the number of resources needed, required skills, etc.

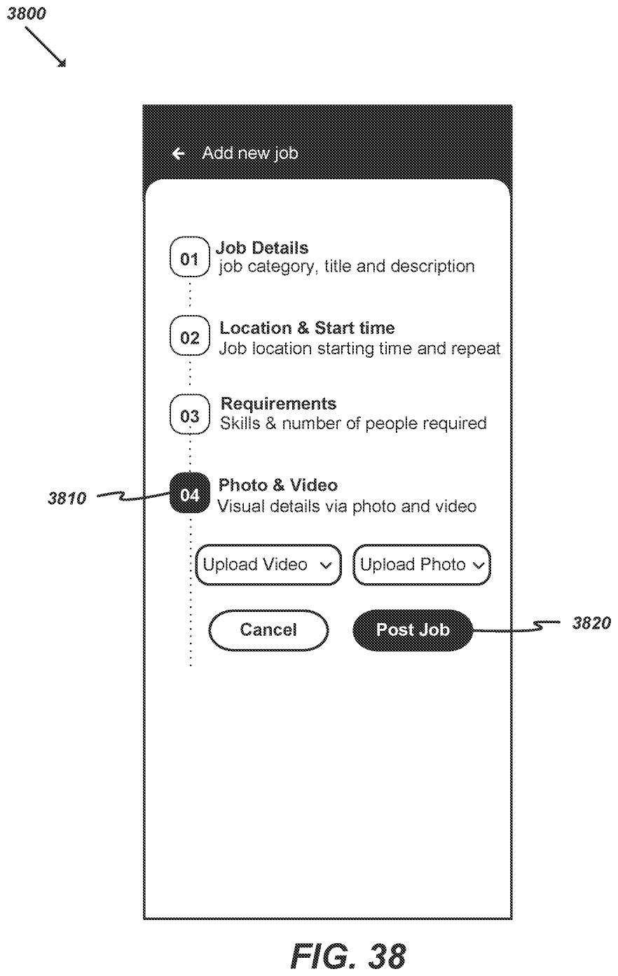

FIG. 38 illustrates an exemplary GUI 3800 that receives job detail information. Such a GUI may be invoked, for instance, by selecting an element such as object 3810. As shown, GUI 3800 may include an action element, such as post job button 3820.

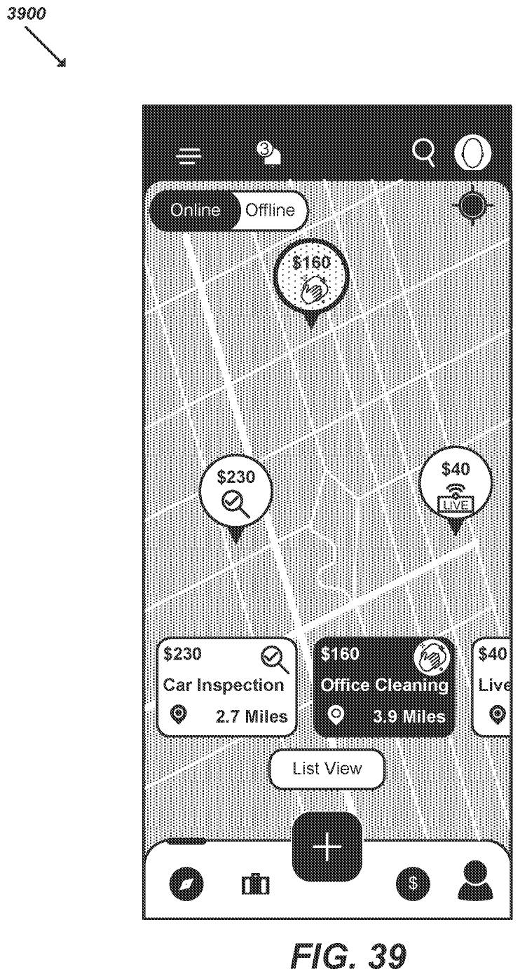

FIG. 39 illustrates an exemplary GUI 3900 that provides job postings. Such a GUI may be invoked, for instance, by selecting an element such as object 2430 described above. As shown, GUI 3900 may be similar to GUI 2500 described above.

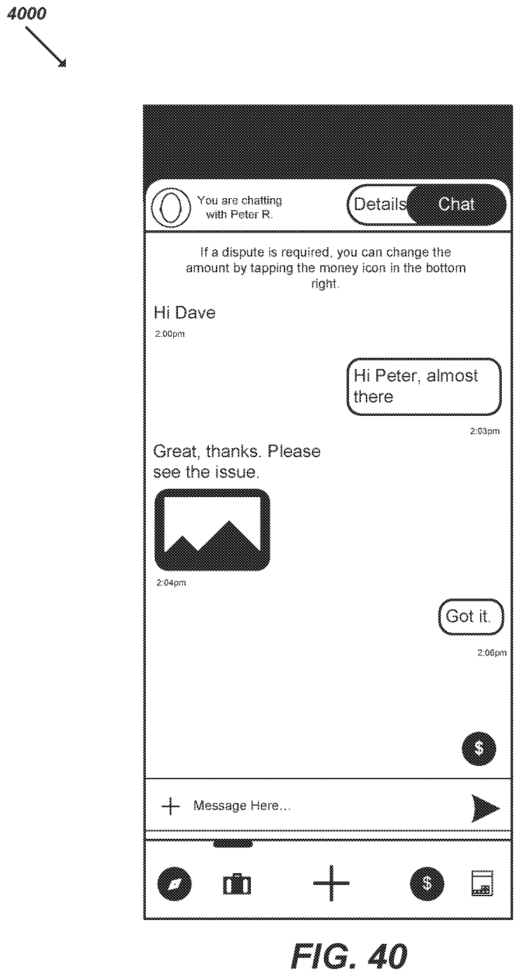

FIG. 40 illustrates an exemplary GUI 4000 that provides communication between parties. Such a GUI may be invoked, for instance, by selecting another user profile, by selecting a job posting, and/or other appropriate ways. As shown, GUI 4000 may include resources such as text and multimedia communication.

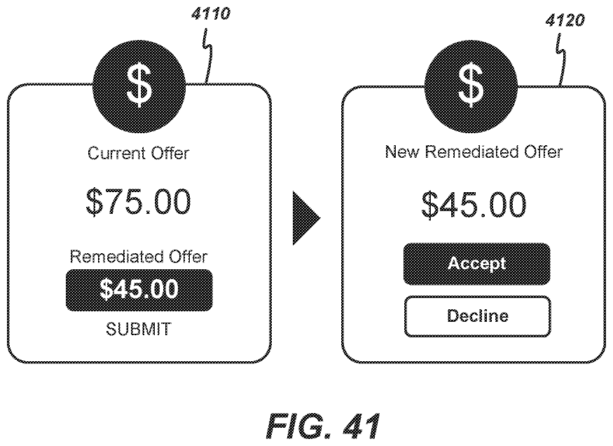

FIG. 41 illustrates exemplary GUIs 4110-4120 that provide dispute resolution. Such GUIs may be invoked, for instance, by selecting a dispute element or otherwise indicating that a job was not performed satisfactorily. As shown, GUI 4110 may include elements that allow a poster-user to propose a remediated payment offer. GUI 4120 may allow a resource-user to accept or decline the remediated offer. Similar GUIs may be used to resolve other types of disputes.

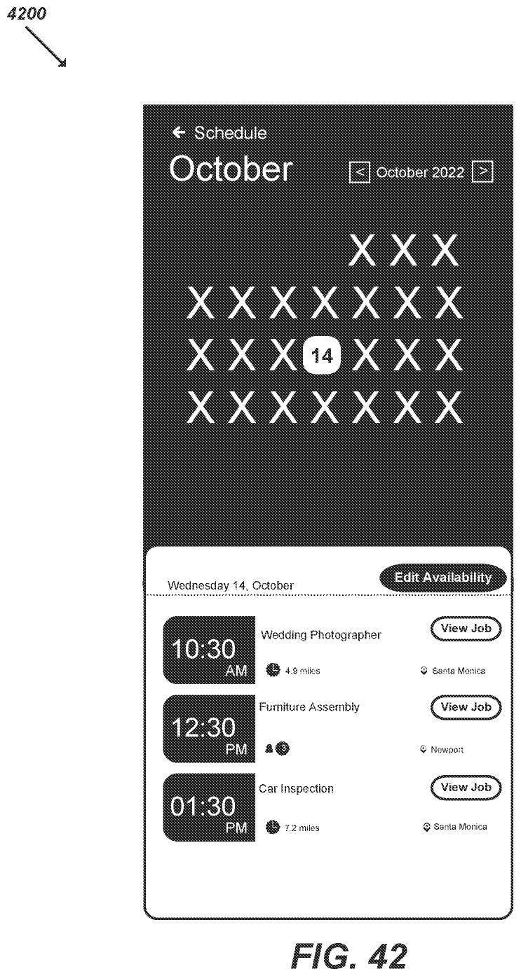

FIG. 42 illustrates an exemplary GUI 4200 that receives scheduling information. Such a GUI may be associated with a resource-user and may allow the user to review and/or edit availability including information regarding previously scheduled jobs (e.g., timing, location, etc.). A similar GUI may be used to allow a poster-user to evaluate and modify scheduling information.

One of ordinary skill in the art will recognize that the GUIs 2400-4200 described above may be implemented in various different ways without departing from the scope of the disclosure. For instance, the various GUI elements may be arranged in different ways, some listed elements may be omitted, and/or some additional elements may be included. In addition, various additional GUIs and/or GUI elements may be invoked and/or eliminated depending on various appropriate criteria (e.g., user selection or preference, default settings, device type or attributes, etc.).

Some other types of GUIs that may be provided by some embodiments include confirmation screens, login or other authentication interfaces, payment and/or billing interfaces, feedback interfaces, and/or media selection or playback interfaces.

### V. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

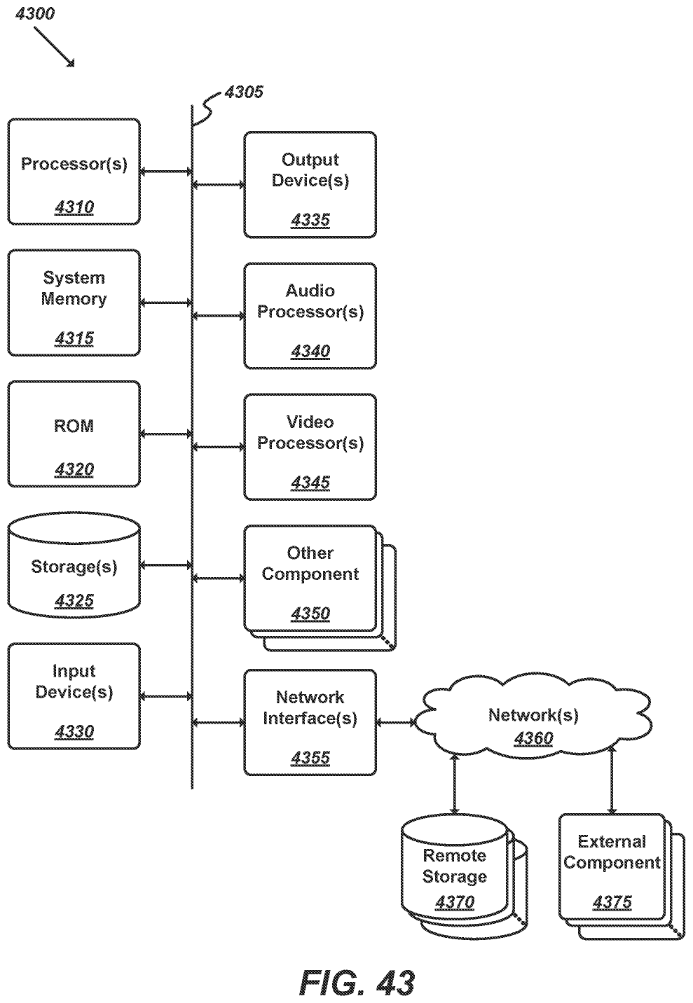

FIG. 43 illustrates a schematic block diagram of an exemplary computer system 4300 used to implement some embodiments. For example, the devices, components, and/or elements described above in reference to FIG. 1-FIG. 5 may be at least partially implemented using computer system 4300. As another example, the processes and algorithms described in reference to FIG. 6-FIG. 22 may be at least partially implemented using sets of instructions that are executed using computer system 4300.

Computer system 4300 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 4300 may include at least one communication bus 4305, one or more processors 4310, a system memory 4315, a read-only memory (ROM) 4320, permanent storage devices 4325, input devices 4330, output devices 4335, audio processors 4340, video processors 4345, various other components 4350, and one or more network interfaces 4355.

Bus 4305 represents all communication pathways among the elements of computer system 4300. Such pathways may include wired, wireless, optical, and/or other appropriate communication pathways. For example, input devices 4330 and/or output devices 4335 may be coupled to the system 4300 using a wireless connection protocol or system.

The processor 4310 may, in order to execute the processes of some embodiments, retrieve instructions to execute and/or data to process from components such as system memory 4315, ROM 4320, and permanent storage device 4325. Such instructions and data may be passed over bus 4305.

System memory 4315 may be a volatile read-and-write memory, such as a random access memory (RAM). The system memory may store some of the instructions and data that the processor uses at runtime. The sets of instructions and/or data used to implement some embodiments may be stored in the system memory 4315, the permanent storage device 4325, and/or the read-only memory 4320. ROM 4320 may store static data and instructions that may be used by processor 4310 and/or other elements of the computer system.

Permanent storage device 4325 may be a read-and-write memory device. The permanent storage device may be a non-volatile memory unit that stores instructions and data even when computer system 4300 is off or unpowered. Computer system 4300 may use a removable storage device and/or a remote storage device as the permanent storage device.

Input devices 4330 may enable a user to communicate information to the computer system and/or manipulate various operations of the system. The input devices may include keyboards, cursor control devices, audio input devices and/or video input devices. Output devices 4335 may include printers, displays, audio devices, etc. Some or all of the input and/or output devices may be wirelessly or optically connected to the computer system 4300.

Audio processor 4340 may process and/or generate audio data and/or instructions. The audio processor may be able to receive audio data from an input device 4330 such as a microphone. The audio processor 4340 may be able to provide audio data to output devices 4340 such as a set of speakers. The audio data may include digital information and/or analog signals. The audio processor 4340 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 4345 (or graphics processing unit) may process and/or generate video data and/or instructions. The video processor may be able to receive video data from an input device 4330 such as a camera. The video processor 4345 may be able to provide video data to an output device 4340 such as a display. The video data may include digital information and/or analog signals. The video processor 4345 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video, such as the GUIs described above in reference to FIG. 25-FIG. 42.

Other components 4350 may perform various other functions including providing storage, interfacing with external systems or components, etc.

Finally, as shown in FIG. 43, computer system 4300 may include one or more network interfaces 4355 that are able to connect to one or more networks 4360. For example, computer system 4300 may be coupled to a web server on the Internet such that a web browser executing on computer system 4300 may interact with the web server as a user interacts with an interface that operates in the web browser. Computer system 4300 may be able to access one or more remote storages 4370 and one or more external components 4375 through the network interface 4355 and network 4360. The network interface(s) 4355 may include one or more APIs that may allow the computer system 4300 to access remote systems and/or storages and also may allow remote systems and/or storages to access computer system 4300 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 4300 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

I claim:

1. A device, comprising:
one or more processors configured to:
receive, from a job poster, a job posting comprising a type, location, schedule, and pay rate;
identify at least one matching resource based on the job posting;
send the job posting to the at least one matching resource;
receive at least one response from the at least one matching resource; and
receive a selection of a first matching resource from among the at least one matching resource.

2. The device of claim 1, the one or more processors further configured to receive a selection of a second matching resource from among the at least one matching resource.

3. The device of claim 1, the one or more processors further configured to:
receive a completion message from the first matching resource; and
receive a confirmation message from the job poster.

4. The device of claim 1, the one or more processors further configured to:
receive payment from the job poster; and
send payment to the first matching resource.

5. The device of claim 1, wherein the job posting further comprises a set of required qualifications and wherein identifying the at least one matching resource comprises verifying that each matching resource from the at least one matching resource satisfies the set of required qualifications.

6. The device of claim 1, the one or more processors further configured to:
receive a dispute message from the first matching resource or the job poster; and
provide a dispute resolution interface to the first matching resource and the job poster.

7. The device of claim 1, wherein the type is selected via a set of categories and associated sub-categories of services.

8. A non-transitory computer-readable medium, storing a plurality of processor-executable instructions to:
receive, from a job poster, a job posting comprising a type, location, schedule, and pay rate;
identify at least one matching resource based on the job posting;
send the job posting to the at least one matching resource;
receive at least one response from the at least one matching resource; and
receive a selection of a first matching resource from among the at least one matching resource.

9. The non-transitory computer-readable medium of claim 8, the plurality of processor-executable instructions further to receive a selection of a second matching resource from among the at least one matching resource.

10. The non-transitory computer-readable medium of claim 8, the plurality of processor-executable instructions further to:
receive a completion message from the first matching resource; and
receive a confirmation message from the job poster.

11. The non-transitory computer-readable medium of claim 8, the plurality of processor-executable instructions further to:
receive payment from the job poster; and
send payment to the first matching resource.

12. The non-transitory computer-readable medium of claim 8, wherein the job posting further comprises a set of required qualifications and wherein identifying the at least one matching resource comprises verifying that each matching resource from the at least one matching resource satisfies the set of required qualifications.

13. The non-transitory computer-readable medium of claim 8, the plurality of processor-executable instructions further to:
receive a dispute message from the first matching resource or the job poster; and
provide a dispute resolution interface to the first matching resource and the job poster.

14. The non-transitory computer-readable medium of claim 8, wherein the type is selected via a set of categories and associated sub-categories of services.

15. A method comprising:
receiving, from a job poster, a job posting comprising a type, location, schedule, and pay rate;
identifying at least one matching resource based on the job posting;
sending the job posting to the at least one matching resource;
receiving at least one response from the at least one matching resource; and
receiving a selection of a first matching resource from among the at least one matching resource.

16. The method of claim 15 further comprising receiving a selection of a second matching resource from among the at least one matching resource.

17. The method of claim 15 further comprising:
receiving a completion message from the first matching resource; and
receiving a confirmation message from the job poster.

18. The method of claim 15 further comprising:
receive payment from the job poster; and
send payment to the first matching resource.

19. The method of claim 15, wherein the job posting further comprises a set of required qualifications and wherein identifying the at least one matching resource comprises verifying that each matching resource from the at least one matching resource satisfies the set of required qualifications.

20. The method of claim 15 further comprising:
receiving a dispute message from the first matching resource or the job poster; and
providing a dispute resolution interface to the first matching resource and the job poster.
